(19) United States
(12) Patent Application Publication
(10) Pub. No.: US 2026/0230551 A1
(43) Pub. Date: Aug. 6, 2026

(54) INFORMATION PROCESSING APPARATUS, INFORMATION PROCESSING SYSTEM, AND INFORMATION PROCESSING METHOD

(71) Applicant: SONY GROUP CORPORATION, TOKYO (JP)

(72) Inventors: DAISUKE SETTAI, TOKYO (JP); TAEKO TANI, TOKYO (JP); TATSUAKI YUKAWA, TOKYO (JP); MINOBU AKIYAMA, TOKYO (JP); HIDENARI SHINOTO, TOKYO (JP)

(21) Appl. No.: 19/149,536

(22) PCT Filed: Dec. 20, 2023
(86) PCT No.: PCT/JP2023/045684

§ 371 Date: Jul. 19, 2025

(30) Foreign Application Priority Data
Jan. 26, 2023 (JP) 2023-010102

(51) Int. Cl. H04M 1/24; G06F 3/01; G06F 3/0484; G06F 3/0488; G06F 3/14; G06F 3/16

(52) U.S. Cl. CPC H04M 1/24; G06F 3/016; G06F 3/0484; G06F 3/0488; G06F 3/14; G06F 3/16

(57) ABSTRACT

A configuration capable of suppressing a temperature rise of a user terminal such as a smartphone and checking a temperature status of the user terminal is provided. In a configuration in which a user non-operation terminal and a user operation terminal are communicably connected, image data generated by the user non-operation terminal executing an app is transmitted to the user operation terminal, and the image data is updated on the basis of user operation information input from the user operation terminal. The user operation terminal displays image data as an application execution result input from the user non-operation terminal on a display unit, and transmits user operation information regarding the user operation terminal to the user non-operation terminal. Furthermore, warning information or the like according to the temperature of the user non-operation terminal is displayed on the user non-operation terminal or the user operation terminal.

### TECHNICAL FIELD

The present disclosure relates to an information processing apparatus, an information processing system, and an information processing method. Specifically, the present disclosure relates to an information processing apparatus, an information processing system, and an information processing method that, in a case where an app (application) such as a game app is executed using an information processing apparatus such as a smartphone, suppress a processing load and a temperature rise of the smartphone, which is an app execution device, and that achieve a comfortable app execution environment.

### BACKGROUND ART

During these years, many users enjoy various apps (applications) such as game apps, for example, using an information processing apparatus such as a smartphone.

In a case where a game app is executed on a smartphone, a game screen is displayed on a display unit of the smartphone, and a user performs various operations to advance a game.

These days, for example, games using 3D (three-dimensional) images and game apps using high-definition images and high-frame-rate images are increasing.

In a case where such an app is executed using a smartphone, a processing load of the smartphone increases, and the smartphone often becomes hot. If the user continues the game for a long time, the smartphone can get too hot for the user to hold the smartphone.

This is mainly caused by a heat generation effect accompanying an increase in a processing load of a data processing unit, such as a CPU, of the smartphone.

Note that many smartphones have a control function for preventing an excessive temperature rise. For example, in a case where temperature has become equal to or higher than a predetermined temperature, control for forcibly decreasing data processing speed of the CPU or the like is executed.

If such control is executed, however, problems such as a decrease in progress speed of a game app and a rough screen occur.

Note that, for example, Patent Document 1 (WO 2022/059585 A) is an example of the background art that discloses a technique for preventing functional degradation of a smartphone due to an increase in temperature.

This patent document discloses a configuration in which, in a case where a user does not touch a smartphone, an upper limit value of reference temperature, which is a start reference temperature of function control, is increased, so that data processing can be executed without deteriorating a function at a high temperature.

This method, however, is control under a condition that the user does not touch the smartphone, and there is a problem that this method cannot be applied, for example, in a case where the user executes a game app with both of his/her hands holding the smartphone.

### CITATION LIST

### Patent Document

Patent Document 1: WO 2022/059585 A

### SUMMARY OF THE INVENTION

### Problems to be Solved by the Invention

The present disclosure has been made in view of the above problems, for example, and an object thereof is to provide an information processing apparatus, an information processing system, and an information processing method capable of providing a comfortable app execution environment by suppressing a processing load and a temperature rise of an app execution device such as a smartphone in a configuration in which various apps such as game apps are executed using a portable device such as a smartphone.

### Solutions to Problems

A first aspect of the present disclosure is
an information processing apparatus including:
a control unit that executes an application; and
a communication unit that executes communication with a connected terminal operated by a user, in which
the control unit
executes processing for transmitting image data generated by executing the application to the connected terminal via the communication unit, and further
updates the generated image data in accordance with user operation information regarding the connected terminal input from the connected terminal via the communication unit and transmits the image data to the connected terminal.

Furthermore, a second aspect of the present disclosure is
an information processing apparatus including:
a communication unit that executes communication with a connected terminal which executes an application; and
a control unit that executes communication control using the communication unit, in which
the control unit
displays, on a display unit, image data as an application execution result input from the connected terminal via the communication unit, and
transmits user operation information regarding the information processing apparatus to the connected terminal via the communication unit.

Furthermore, a third aspect of the present disclosure is
an information processing system including:
a user non-operation terminal and a user operation terminal, in which
the user non-operation terminal executes
processing for transmitting image data generated by executing an application to the user operation terminal via a communication unit, and
processing for updating the image data on a basis of user operation information input from the user operation terminal via the communication unit, and
the user operation terminal executes
processing for displaying, on a display unit, the image data as an application execution result input from the user non-operation terminal via the communication unit, and
processing for transmitting the user operation information regarding the information processing apparatus to the user non-operation terminal via a communication unit.

Furthermore, a fourth aspect of the present disclosure is
an information processing method executed by an information processing apparatus,
the information processing apparatus including:
a control unit that executes an application; and
a communication unit that executes communication with a connected terminal operated by a user,
the information processing method including:
executing, using the control unit, processing for transmitting image data generated by executing the application to the connected terminal via the communication unit; and further
updating, using the control unit, the generated image data in accordance with user operation information regarding the connected terminal input from the connected terminal via the communication unit and transmitting the image data to the connected terminal.

Note that a program in the present disclosure is, for example, a program that can be provided by a storage medium or a communication medium that provides the program in a computer-readable format for an information processing apparatus or a computer system capable of executing various program codes. By providing such a program in a computer-readable format, processing corresponding to the program is achieved on the information processing apparatus or the computer system.

Other objects, features, and advantages of the present disclosure will become apparent from detailed description based on embodiments of the present disclosure described later and the accompanying drawings. Note that, in the present specification, a system is a logical set configuration of a plurality of apparatuses, and is not limited to one in which apparatuses with various configurations are in the same housing.

With the configuration according to an embodiment of the present disclosure, a configuration capable of suppressing a temperature rise of a user terminal such as a smartphone and checking a temperature status of the user terminal is achieved.

Specifically, for example, in a configuration in which a user non-operation terminal and a user operation terminal are communicably connected to each other, image data generated by the user non-operation terminal executing an app is transmitted to the user operation terminal, and the image data is updated on the basis of user operation information input from the user operation terminal. The user operation terminal displays image data as an application execution result input from the user non-operation terminal on the display unit, and transmits user operation information regarding the user operation terminal to the user non-operation terminal. Furthermore, warning information or the like according to the temperature of the user non-operation terminal is displayed on the user non-operation terminal or the user operation terminal.

With these configurations, a configuration capable of suppressing a temperature rise of a user terminal such as a smartphone and checking a temperature status of the user terminal is achieved.

Note that effects described herein are merely examples and are not limited, and additional effects may also be provided.

### BRIEF DESCRIPTION OF DRAWINGS

FIG. 1 is a diagram illustrating an application execution example using a smartphone.

FIG. 2 is a diagram illustrating an outline of processing executed by the smartphone, which is an example of an information processing apparatus in the present disclosure.

FIG. 3 is a diagram illustrating an example of processing for connecting a user operation terminal and a user non-operation terminal to each other.

FIG. 4 is a diagram illustrating an operation of the user operation terminal after the user operation terminal and the user non-operation terminal are connected to each other.

FIG. 5 is a diagram illustrating an operation of the user non-operation terminal after the user operation terminal and the user non-operation terminal are connected to each other.

FIG. 6 is a diagram illustrating an example of a user interface (UI) displayed on a display unit of the terminal when the user operation terminal and the user non-operation terminal are connected to each other.

FIG. 7 is a diagram illustrating an example of a UI for inputting connection setting information used when the user operation terminal and the user non-operation terminal are connected to each other.

FIG. 8 is another diagram illustrating the example of the UI for inputting connection setting information used when the user operation terminal and the user non-operation terminal are connected to each other.

FIG. 9 is a diagram of a flowchart illustrating a processing sequence at a time when the user operation terminal and the user non-operation terminal are connected to each other.

FIG. 10 is a diagram illustrating a specific example of a state in which the user operation terminal and the user non-operation terminal are connected to each other, and a user executes a game app while holding the user operation terminal in his/her hands.

FIG. 11 is a diagram illustrating a graph in which terminal surface temperature is set on a vertical axis and continuous contact time with respect to the terminal is set on the horizontal axis, and a line (Twarn) on which it is determined that a warning is necessary and a line (Tceil) on which it is necessary to stop the use (operation) are shown.

FIG. 12 is a diagram illustrating three references according to the terminal temperature, that is, reference 1, reference 2, and reference 3, and processing according to these three references.

FIG. 13 is a diagram illustrating examples of a warning screen displayed on a display unit of the user non-operation terminal.

FIG. 14 is a diagram illustrating other examples of the warning screen displayed on the display unit of the user non-operation terminal.

FIG. 15 is a diagram illustrating another example of the warning screen displayed on the display unit of the user non-operation terminal.

FIG. 16 is a diagram illustrating another example of the warning screen displayed on the display unit of the user non-operation terminal.

FIG. 17 is a diagram illustrating other examples of the warning screen displayed on the display unit of the user non-operation terminal.

FIG. 18 is a diagram illustrating a state transition accompanying changes in the temperature of the user non-operation terminal and user operations.

FIG. 19 is a diagram of a flowchart illustrating warning output executed by a control unit of the user non-operation terminal and a sequence of a process for controlling function restriction.

FIG. 20 is a diagram of another flowchart illustrating the warning output executed by the control unit of the user non-operation terminal and the sequence of the process for controlling the function restriction.

FIG. 21 is a diagram illustrating an embodiment in which temperature information regarding the connected terminal is displayed on the display unit of the user operation terminal in a state in which the user operation terminal and the user non-operation terminal are connected to each other and the user executes a game app while holding the user operation terminal in his/her hands.

FIG. 22 is a diagram illustrating specific examples of a “connected terminal temperature identification icon” displayed on the display unit of the user operation terminal.

FIG. 23 is a diagram illustrating other specific examples of the “connected terminal temperature identification icon” displayed on the display unit of the user operation terminal.

FIG. 24 is a diagram illustrating a “connected terminal operability message” displayed on the display unit of the user operation terminal.

FIG. 25 is a diagram illustrating specific examples of the “connected terminal operability message” displayed on the display unit of the user operation terminal.

FIG. 26 is a diagram of a flowchart illustrating a sequence of displaying icons and messages on the display unit of the user operation terminal.

FIG. 27 is a diagram of another flowchart illustrating the sequence of displaying icons and messages on the display unit of the user operation terminal.

FIG. 28 is a diagram of another flowchart illustrating the sequence of displaying icons and messages on the display unit of the user operation terminal.

FIG. 29 is a diagram illustrating processing for disconnecting the user operation terminal and the user non-operation terminal from each other.

FIG. 30 is a diagram illustrating an embodiment in which warning notification is performed when the user operation terminal and the user non-operation terminal are disconnected from each other.

FIG. 31 is a diagram illustrating another embodiment in which the warning notification is performed when the user operation terminal and the user non-operation terminal are disconnected from each other.

FIG. 32 is a diagram illustrating another embodiment in which the warning notification is performed when the user operation terminal and the user non-operation terminal are disconnected from each other.

FIG. 33 is a diagram illustrating another embodiment in which the warning notification is performed when the user operation terminal and the user non-operation terminal are disconnected from each other.

FIG. 34 is a diagram illustrating another embodiment in which the warning notification is performed when the user operation terminal and the user non-operation terminal are disconnected from each other.

FIG. 35 is a diagram illustrating another embodiment in which the warning notification is performed when the user operation terminal and the user non-operation terminal are disconnected from each other.

FIG. 36 is a diagram illustrating another embodiment in which the warning notification is performed when the user operation terminal and the user non-operation terminal are disconnected from each other.

FIG. 37 is a diagram illustrating another embodiment in which the warning notification is performed when the user operation terminal and the user non-operation terminal are disconnected from each other.

FIG. 38 is a diagram illustrating another embodiment in which the warning notification is performed when the user operation terminal and the user non-operation terminal are disconnected from each other.

FIG. 39 is a diagram of a flowchart illustrating a processing sequence in an embodiment in which the warning notification is performed when the user operation terminal and the user non-operation terminal are disconnected from each other.

FIG. 40 is a diagram of another flowchart illustrating the processing sequence in the embodiment in which the warning notification is performed when the user operation terminal and the user non-operation terminal are disconnected from each other.

FIG. 41 is a diagram illustrating a configuration example of the information processing apparatus in the present disclosure.

FIG. 42 is a diagram illustrating a hardware configuration example of the information processing apparatus in the present disclosure.

### MODE FOR CARRYING OUT THE INVENTION

An information processing apparatus, an information processing system, and an information processing method in the present disclosure will be described hereinafter in detail with reference to the drawings. Note that the description will be made in accordance with the following items.
1. Example of Execution of Application Using Smartphone
2. Example of App Execution Configuration Using Information Processing Apparatus in Present Disclosure
3. Processing for Connecting User Terminals and Operation of Each User Terminal After Connection
4. Specific Example of UI (User Interface) Used When Processing for Connecting Terminals Is Executed
5. Detection of Change in Temperature of User Terminal and Processing for Outputting Warning
6. Warning Output Executed by User Non-Operation Terminal and Sequence of Process for Controlling Function Restriction
7. Embodiment in Which Temperature State of User Non-Operation Terminal Is Displayed on Display Unit of User Operation Terminal
8. Sequence of Process for Displaying Temperature State of User Non-Operation Terminal on Display Unit of User Operation Terminal
9. Embodiment in Which Warning Notification Is Performed When User Operation Terminal and User Non-Operation Terminal Are Disconnected from Each Other
10. Other Embodiments and Application Examples
11. Configuration Example of Information Processing Apparatus in Present Disclosure
12. Hardware Configuration Example of Information Processing Apparatus in Present Disclosure
13. Summary of Configuration in Present Disclosure

### 1. Example of Execution of Application Using Smartphone

First, an example of execution of an application using a smartphone will be described.

The information processing apparatus in the present disclosure is an apparatus capable of executing various applications such as game apps, and specifically, for example, is an information processing apparatus such as a smartphone.

The user can execute various apps (applications), such as game apps, using the smartphone.

In a case where a game app is executed on the smartphone, a game app execution screen is displayed on a display unit of the smartphone, and the user performs various operations to advance a game.

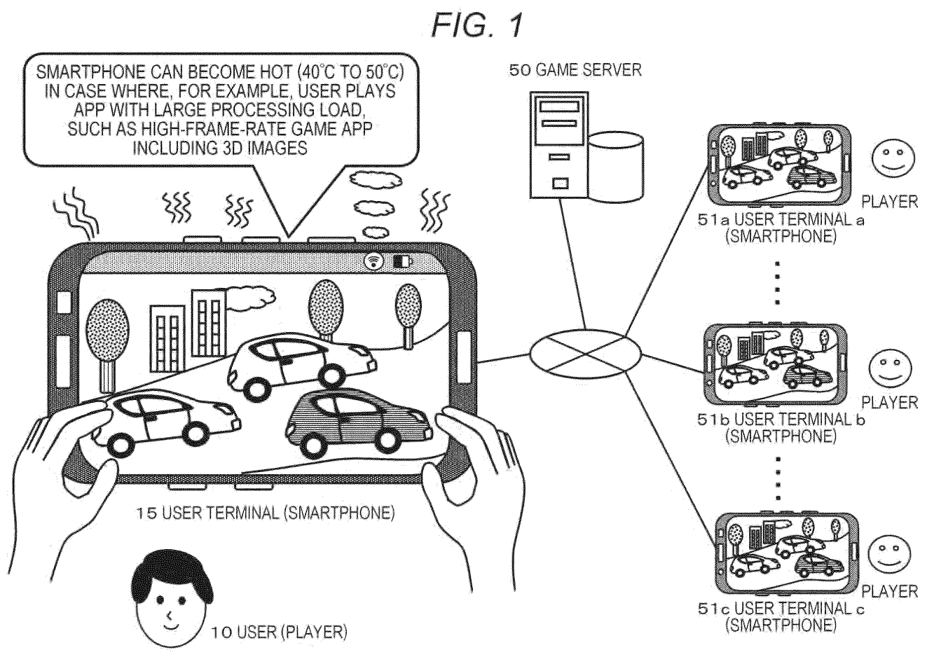

FIG. 1 is a diagram illustrating an example of execution of an application using a smartphone.

FIG. 1 illustrates a user terminal (smartphone) 15, which is an example of the information processing apparatus in the present disclosure. A user (player) 10 is executing a game app while holding the user terminal 15 in his/her hands. FIG. 1 illustrates an example in which a game app of an automobile race is executed as an example.

The user terminal 15 is connected to a game server 50 via a network.

The game server 50 is also connected to user terminals (smartphones) a and 51a to c and 51c of a large number of players participating in the game via the network.

The players having the user terminals connected via the network are players who simultaneously enjoy the game race app.

The game server 50 executes data distribution management between the user terminals of the plurality of players, that is, for example, distribution processing of operation information regarding each player, chat distribution processing between the players, and the like.

In a case where a game app being executed in the user terminal 15 illustrated in FIG. 1 is, for example, a game app using 3D (three-dimensional) images, high-definition images, or high-frame-rate images, however, there is a high possibility that a processing load of a data processing unit, such as a CPU, of the user terminal 15 increases and the smartphone becomes hot.

If the user 10 continues the game app for a long time, the user terminal 15 becomes hot, and the user 10 might not be able to continue the game while holding the user terminal 15.

Many smartphones have a control function for preventing an excessive temperature rise, and if temperature becomes equal to or higher than a predetermined temperature, for example, control for forcibly decreasing data processing speed of the CPU or the like is executed. If such control is executed, however, problems such as a decrease in progress speed of a game app and a rough screen occur.

The present disclosure solves these problems, and provides a comfortable app execution environment by suppressing a processing load and a temperature rise of an app execution device such as a smartphone.

### 2. Example of App Execution Configuration Using Information Processing Apparatus in Present Disclosure

Next, an example of an app execution configuration using a smartphone, which is an example of the information processing apparatus according to the present disclosure, will be described.

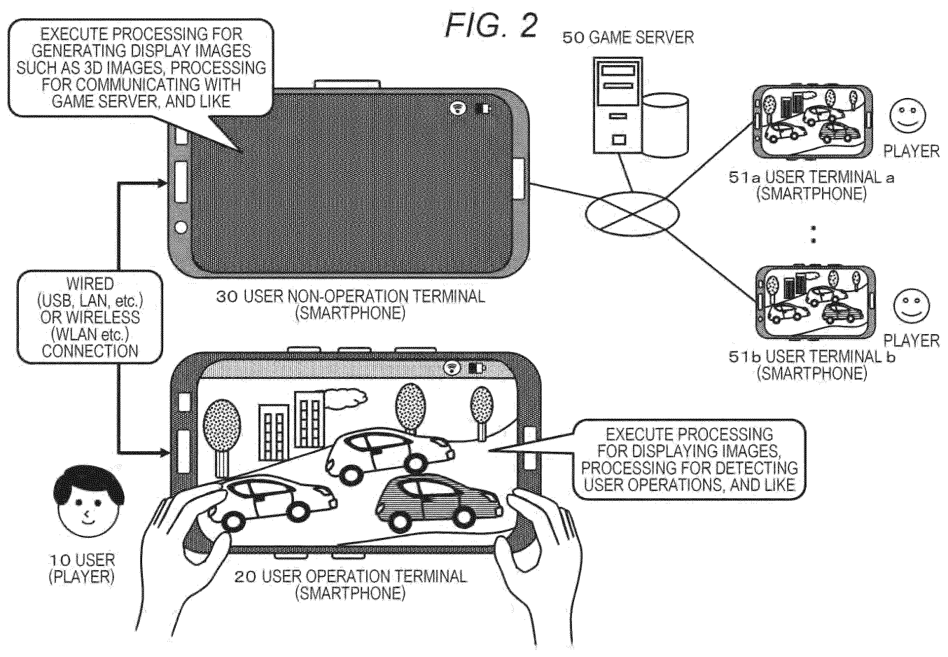

The example of the app execution configuration using the smartphone, which is an example of the information processing apparatus according to the present disclosure, will be described with reference to FIG. 2.

FIG. 2 illustrates an example in which the user (player) 10 executes a game app of an automobile race using smartphones as in the description with reference to FIG. 1.

In the example illustrated in FIG. 2, the user 10 uses two user terminals (smartphones). That is, two user terminals (smartphones), namely
a user operation terminal (smartphone) 20, and
a user non-operation terminal (smartphone) 30,
are communicably connected to each other, and the game app is executed.

Specifically, the user operation terminal 20 and the user non-operation terminal 30 are connected to each other via a communication path established by wired connection such as USB or LAN or wireless connection such as WLAN (wireless LAN), for example, and are in a state of being able to communicate data with each other.

The user operation terminal 20 is a terminal such as a smartphone with which the user 10 performs operations while holding it in his/her hands. The game app execution screen is displayed on the user operation terminal 20, and the user 10 performs various operations including, for example, touch processing on the screen, a button operation, and the like on the user operation terminal 20 to advance the game app.

The user non-operation terminal 30 connected to the user operation terminal 20, on the other hand, is a terminal, such as a smartphone, that need not be held by the user 10 in his/her hands.

In the user non-operation terminal 30, a control unit executes an app such as a game app. The game app execution screen, however, is not displayed on the user non-operation terminal 30.

The user non-operation terminal 30 executes an application such as the game app to execute processing for generating a display image to be displayed on a display unit of the user operation terminal 20, that is, processing for generating a 3D (three-dimensional) image, for example, processing for communicating with the game server 50 via the network, and the like.

The user non-operation terminal 30 receives user operation information regarding a user operation executed on the user operation terminal 20, that is for example, touch processing on the screen or a button operation, via the communication path between the user non-operation terminal 30 and the user operation terminal 20.

The user non-operation terminal 30 executes processing for generating and updating a display image, that is, for example, a 3D (three-dimensional) image, on the basis of the user operation information received via the communication path, and sequentially transmits generated and updated image frames to the user operation terminal 20 via the communication path.

The user operation terminal 20 displays the image frames sequentially received from the user non-operation terminal 30 on the display unit of the user operation terminal 20.

As described above, main data processing whose processing load is large, such as processing for generating a 3D (three-dimensional) image, is executed in the user non-operation terminal 30 not held by the user 10 in his/her hands to reduce a processing load of the user operation terminal 20 held by the user 10 in his/her hands, thereby reducing a temperature rise of the user operation terminal 20.

As a result, even in a game app using 3D (three-dimensional) images, high-definition images, or high-frame-rate images whose processing load is large, the user operation terminal 20 held by the user 10 in his/her hands is less likely to become hot, and the user 10 can continuously execute the game app for a long time.

Note that the user non-operation terminal 30 also sequentially transmits sound data and vibration data generated by executing the application to the user operation terminal 20 via the communication path.

The user operation terminal 20 also outputs the sound data and the vibration data sequentially received from the user non-operation terminal 30 using a speaker or a vibration function of the user operation terminal 20.

In addition, the user non-operation terminal 30 also executes processing for updating the sound data and the vibration data to be generated in accordance with the user operation information received from the user operation terminal 20.

### 3. Processing for Connecting User Terminals and Operation of Each User Terminal After Connection

Next, processing for connecting user terminals and operation of each user terminal will be described.

The following items will be sequentially described.
(1) Processing for Connecting User Operation Terminal and User Non-Operation Terminal to Each Other
(2) Operation of User Operation Terminal After Terminal Connection
(3) Operation of User Non-Operation Terminal After Terminal Connection

### (3-(1) Processing for Connecting User Operation Terminal and User Non-Operation Terminal to Each Other)

First, processing for connecting the user operation terminal and the user non-operation terminal to each other will be described.

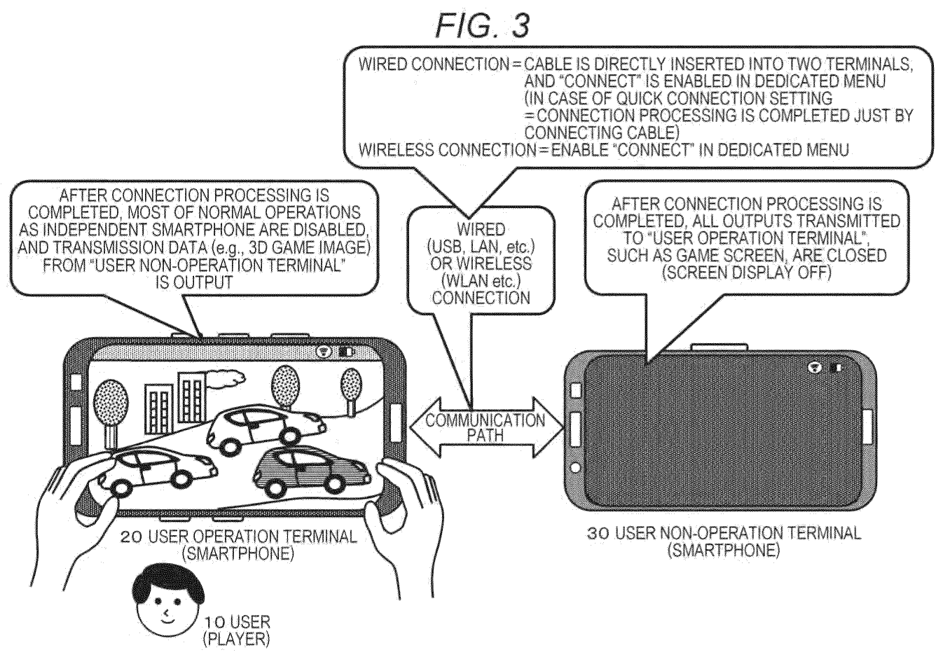

FIG. 3 is a diagram illustrating the processing for connecting the user operation terminal 20 and the user non-operation terminal 30 to each other.

As described above, the user operation terminal 20 and the user non-operation terminal 30 are connected to each other such that a communication path for enabling mutual communication is established by, for example, either wired connection such as USB or LAN, or wireless connection such as WLAN (wireless LAN).

For example, in a case where wired connection such as USB or LAN is established, a connection cable is inserted into both of the user operation terminal 20 and the user non-operation terminal 30, and then processing for enabling connection between the two terminals is performed using a user interface (UI) displayed on the display unit of either the user operation terminal 20 or the user non-operation terminal 30.

Note that, in a case where a setting (quick connection setting) for automatically enabling the communication path between the two terminals by inserting a connection cable into both the user operation terminal 20 and the user non-operation terminal 30 is made in advance, a user input via the UI is unnecessary.

In a case where wireless connection such as WLAN (wireless LAN) is established, on the other hand, a wirelessly connectable terminal is selected using a user interface (UI) displayed on the display unit of either the user operation terminal 20 or the user non-operation terminal 30, and processing for enabling connection of the selected terminal is performed.

When the processing for connecting the user operation terminal 20 and the user non-operation terminal 30 to each other is completed and the communication path between the two terminals is set, the user operation terminal 20 executes processing for outputting data (image, sound, and vibration information and the like) input from the user non-operation terminal 30 via the communication path and processing for transmitting user operation (screen touch, button operations, and the like) information to the user non-operation terminal 30 via the communication path, but many of other normal operations as an independent smartphone are disabled.

The CPU of the user operation terminal 20 does not perform, for example, processing for generating a 3D image to be used as a display image of the game app, but performs processing for outputting 3D image data input from the user non-operation terminal 30 via the communication path to the display unit.

When the processing for connecting the user operation terminal 20 and the user non-operation terminal 30 to each other is completed and the communication path between the two terminals is set, on the other hand, the user non-operation terminal 30 executes an app such as a game application and executes the processing for generating a 3D image to be used as a display image of the game app.

The generated image, however, is transmitted to the user operation terminal 20 without being displayed on the display unit of the user non-operation terminal 30.

Note that the image generated by the user non-operation terminal 30 is sequentially updated in accordance with user operation information or the like input from the user operation terminal 20 via the communication path.

With respect to the voice information, the vibration information, and the like, too, the user non-operation terminal 30 transmits, to the user operation terminal 20 via the communication path, information generated while sequentially updating an output mode in accordance with the user operation information and the like input from the user operation terminal 20 via the communication path.

In addition, the user non-operation terminal 30 also executes communication with the game server 50 via an external network such as the Internet, executes processing for generating output information regarding an image, a sound, vibration and the like according to operation information regarding other players and chat information, and transmits generated image, sound, vibration information and the like to the user operation terminal 20 via the communication path.

The user operation terminal 20 outputs the output information such as the image, sound, and vibration information received from the user non-operation terminal 30 using the display unit, the speaker, and the vibration function of the user operation terminal 20 such that all the output information is reproduced in the user operation terminal 20.

As described above, the user non-operation terminal 30 executes data processing relating to an app such as a game app. Data output processing such as image output to the display unit, sound output via the speaker, and vibration processing using the vibration function, however, is not executed.

Next, operation of each terminal after the processing for connecting the user operation terminal 20 and the user non-operation terminal 30 to each other is completed and the communication path between the two terminals is set will be described.

### (3-(2) Operation of User Operation Terminal After Terminal Connection)

Next, the operation of the user operation terminal 20 after the terminal connection will be described.

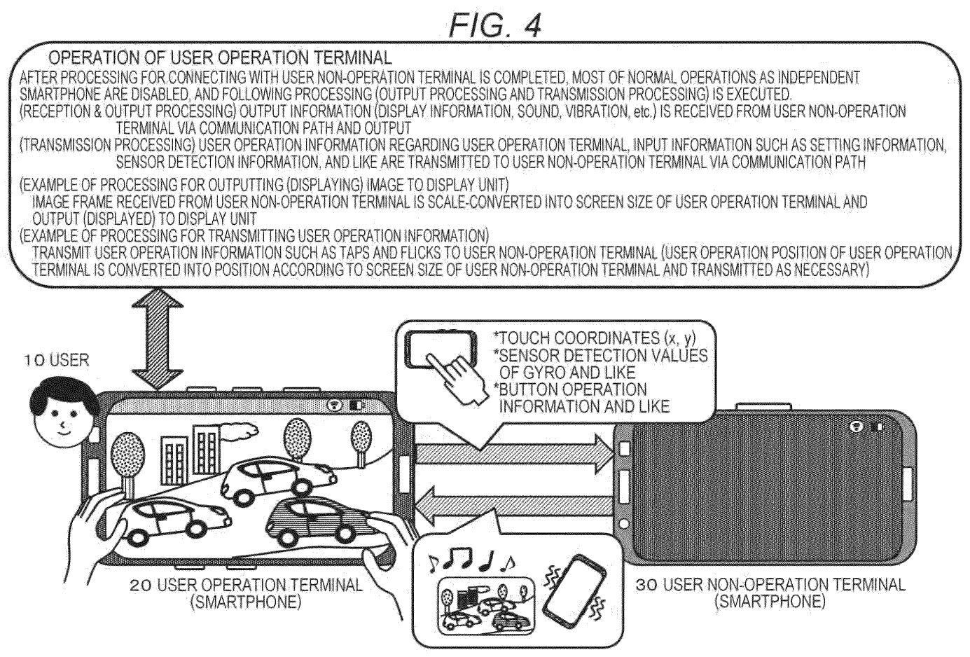

The operation of the user operation terminal 20 after the user operation terminal 20 and the user non-operation terminal 30 are connected to each other will be described with reference to FIG. 4.

As illustrated in FIG. 4, when the user operation terminal 20 and the user non-operation terminal 30 are connected to each other and the communication path between the two terminals is set, many of the normal operations of the user operation terminal 20 as an independent smartphone are disabled, and the following processing (output processing and transmission processing) is executed.
(Reception & output processing) Processing for receiving and outputting output information (display information, a sound, vibration, and the like) from the user non-operation terminal 30 via the communication path
(Transmission processing) Processing for transmitting input information such as user operation information and setting information regarding the user operation terminal 20 and sensor detection information to the user non-operation terminal 30 via the communication path
   (Reception & output processing) executed by the user operation terminal 20 will be described.

The output information received by the user operation terminal 20 from the user non-operation terminal 30 via the communication path is information such as display information, a sound, and vibration.

The user operation terminal 20 successively receives image frames from the user non-operation terminal 30, and sequentially outputs the input image frames to the display unit of the user operation terminal 20.

In a case where the user operation terminal 20 executes image output at a frame rate of 120 fps, for example, the user operation terminal 20 receives the image at a frame rate of 120 fps from the user non-operation terminal 30, and sequentially outputs the image to the display unit.

Note that, in a case where size of the image received from the user non-operation terminal 30 does not match screen size of the user operation terminal 20, the user operation terminal 20 performs processing for scale-converting the image received from the user non-operation terminal 30 into the screen size thereof and outputs the image to the display unit.

The scale conversion processing for the image size may be executed on a user non-operation terminal 30 side.

In addition, in a case where the user operation terminal 20 receives the sound information from the user non-operation terminal 30 via the communication path, the received sound information is output via the speaker of the user operation terminal 20.

Furthermore, in a case where the user operation terminal 20 receives vibration information from the user non-operation terminal 30 via the communication path, the user operation terminal 20 outputs the received vibration information using the vibration function thereof.

Next, (transmission processing) executed by the user operation terminal 20 will be described.

The user operation terminal 20 performs the processing for transmitting input information such as user operation information and setting information regarding the user operation terminal 20 to the user non-operation terminal 30 via the communication path.

The user operation terminal 20 transmits user operation information regarding user operations performed thereon, that is, for example, touch processing on the screen and operations performed on buttons and switches of the user operation terminal 20, and sensor detection information to the user non-operation terminal 30 via the communication path.

In a case where an operation target of the user is the screen of the user operation terminal 20, the user operation terminal 20 obtains operation screen position information and touch mode (taps, flicks, swipes, and the like) information and transmits the obtained information to the user non-operation terminal 30.

Note that the user operation terminal 20 converts the operation screen position information into a position corresponding to the screen size of the user non-operation terminal 30 and transmits the position.

The processing for converting the operation screen position information, however, need not be executed by the user operation terminal 20, but may be executed by the user non-operation terminal 30.

Furthermore, the user operation terminal 20 also transmits detected values of various sensors included in the user operation terminal 20, such as a gyro sensor, to the user non-operation terminal 30.

As can be understood from the description with reference to FIG. 4, the user operation terminal 20 mainly performs the following two types of processing.
(Reception & output processing) Processing for receiving and outputting output information (display information, a sound, vibration, and the like) from the user non-operation terminal 30 via the communication path
(Transmission processing) Processing for transmitting input information such as user operation information and setting information regarding the user operation terminal 20 and sensor detection information to the user non-operation terminal 30 via the communication path

That is, the user operation terminal 20 does not execute data processing with a large processing load, such as the processing for generating a 3D image. As a result, an excessive temperature rise is not caused.

The possibility that the user operation terminal 20 becomes hot, therefore, is reduced, and the user can play the game for a long time while holding the user operation terminal 20 in his/her hands.

### (3-(3) Operation of User Non-Operation Terminal After Terminal Connection)

Next, the operation of the user non-operation terminal 30 after the terminal connection will be described.

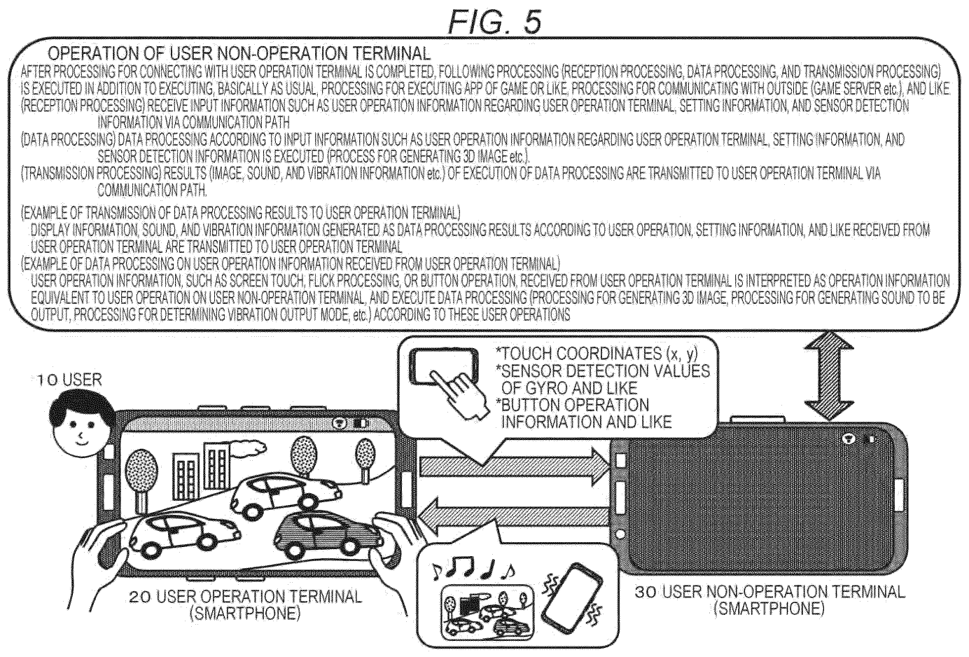

The operation of the user non-operation terminal 30 after the user operation terminal 20 and the user non-operation terminal 30 are connected to each other will be described with reference to FIG. 5.

As illustrated in FIG. 5, when the user operation terminal 20 and the user non-operation terminal 30 are connected to each other and the communication path between the two terminals is set, the user non-operation terminal 30 basically executes processing for executing an application such as a game, processing for communicating with the outside (the game server or the like), and the like as usual under the control of the control unit, and executes the following processing (reception processing, data processing, and transmission processing).
(Reception processing) Input information such as user operation information and setting information regarding the user operation terminal 20 and sensor detection information is received via the communication path.
(Data processing) Data processing (processing for generating a 3D image and the like) according to input information such as user operation information, setting information, and sensor detection information in the user operation terminal 20 is executed.
(Transmission processing) Data (image, sound, and vibration information, etc.) generated by executing the data processing is transmitted to the user operation terminal via the communication path.

(Reception Processing) Executed by the User Non-operation terminal 30 will be described.

The user non-operation terminal 30 receives user operation information regarding user operations performed on the user operation terminal 20, that is, for example, touch processing on the screen and operations performed on the buttons and the switches of the user operation terminal 20, and sensor detection information via the communication path.

In a case where the operation target of the user is the screen of the user operation terminal 20, the user non-operation terminal 30 receives, as described above, operation screen position information and touch mode (taps, flicks, swipes, and the like) information regarding the user operation terminal 20 from the user operation terminal 20.

Note that, with respect to the operation screen position information, as described above, a setting for receiving data converted into the position corresponding to the screen size of the user non-operation terminal 30 or a setting for executing the processing for converting the operation screen position information using not the user operation terminal 20 but the user non-operation terminal 30 is made.

Furthermore, the user non-operation terminal 30 also receives the detected values of the various sensors included in the user operation terminal 20, such as the gyro sensor.

Next, (reception processing) executed by the user non-operation terminal 30 will be described.

The user non-operation terminal 30 executes an application such as the game app under the control of the control unit. Furthermore, the user non-operation terminal 30 executes data processing according to input information such as user operation information, setting information, and sensor detection information in the user operation terminal 20.

Specifically, for example, the processing for generating a 3D image, the processing for generating sound information, the processing for generating vibration information, and the like are executed.

The user non-operation terminal 30 executes an application such as the game app under the control of the control unit, sequentially updates image data, sound data, vibration data, and the like to be generated on the basis of input information, such as user operation information, setting information, and sensor detection information, input from the user operation terminal 20 via the communication path, and transmits the updated data to the user operation terminal 20.

That is, the user non-operation terminal 30 interprets user operation information, such as screen touch, flick processing, and button operations, sensor detection values, and the like received from the user operation terminal 20 as the same information as user operations and sensor detection values with respect to the user non-operation terminal 30, and executes the data processing (the processing for generating a 3D image, the processing for generating an output sound, the processing for determining an output mode of vibration, and the like) according to the user operation information and the sensor detection values received from the user operation terminal 20.

For example, the control unit of the user non-operation terminal 30 receives touch position information and touch mode (taps, flicks, swipes, and the like) information regarding the user on the display unit of the user operation terminal 20, executes the data processing (the processing for generating a 3D image, the processing for generating an output sound, the processing for determining an output mode of vibration, and the like) according to the input touch position information and touch mode (taps, flicks, swipes, and the like) information, and executes processing for generating and updating output data (image data, sound data, vibration data, and the like) as execution results.

Next, (transmission processing) executed by the user non-operation terminal 30 will be described.

The user non-operation terminal 30 transmits data (image, sound, and vibration information and the like) generated by executing the data processing to the user operation terminal 20 via the communication path.

As described above, the user non-operation terminal 30 executes processing for generating image, sound, and vibration information according to input information, such as user operation information, setting information, and sensor detection information, in the user operation terminal 20, and transmits the generated information to the user operation terminal 20.

The user operation terminal 20 outputs the information, such as an image, a sound, and vibration, input from the user non-operation terminal 30 using the display unit, the speaker, and the vibration function thereof.

As described above, the user operation terminal 20 successively receives image frames from the user non-operation terminal 30, and sequentially outputs the input image frames to the display unit of the user operation terminal 20.

In a case where the user operation terminal 20 executes image output at a frame rate of 120 fps, for example, the user non-operation terminal 30 transmits the image at a frame rate of 120 fps to the user operation terminal 20.

Note that the user non-operation terminal 30 may be configured to perform processing for executing scale conversion to obtain an image according to the size of the display unit of the user operation terminal 20 and transmitting the image after the scale conversion to the user operation terminal 20.

The scale conversion processing for the image size, however, may be executed not on the user non-operation terminal 30 side but by the user operation terminal 20.

### 4. Specific Example of UI (User Interface) Used When Processing for Connecting Terminals Is Executed

Next, a specific example of a UI (user interface) used when the process for connecting the terminals is executed will be described.

As described above, the user operation terminal 20 and the user non-operation terminal 30 are connected to each other such that a communication path for enabling mutual communication is established by, for example, either wired connection such as USB or LAN, or wireless connection such as WLAN (wireless LAN).

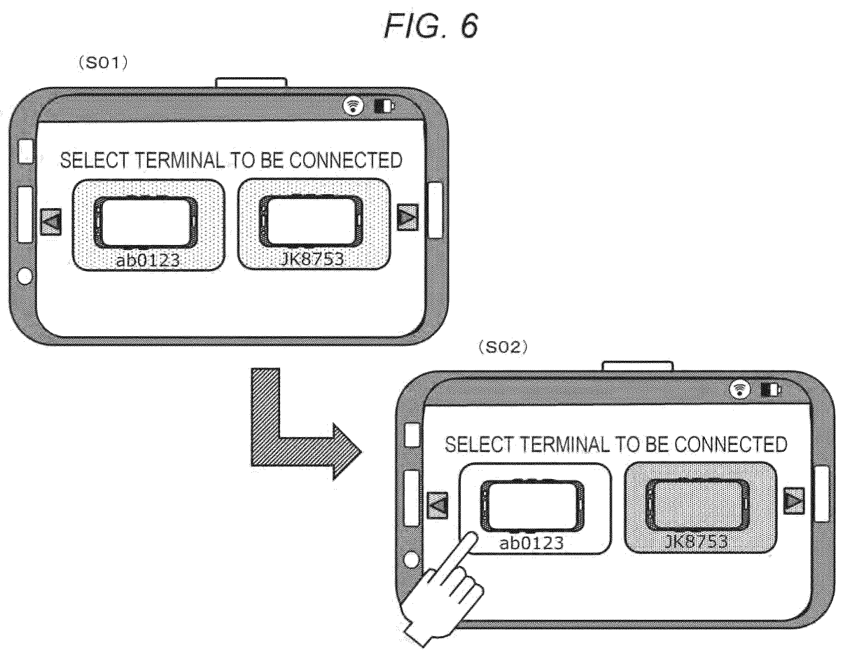

FIG. 6 is an example of a user interface (UI) displayed on the display unit of the terminal when the user operation terminal 20 and the user non-operation terminal 30 are connected to each other. Note that the UI can be displayed on any of the user operation terminal 20 and the user non-operation terminal 30.

The control units of the user operation terminal 20 and the user non-operation terminal 30 execute processing for displaying, on the display units, a user interface (UI) for setting a communication mode with the connected terminal.

The example illustrated in FIG. 6 is an example in a case where a plurality of terminals connectable by, for example, a wireless LAN (WLAN) is detected, and the user selects one of these detected terminals as a terminal to be connected.

The example illustrated in the drawing is an example in which the user selects a terminal (ab0123) as the terminal to be connected.

Note that, for example, in a case where only one terminal is connected by wired connection such as USB or LAN, one terminal connected to a cable is determined as the terminal to be connected, and a selection screen illustrated in FIG. 6 is not displayed.

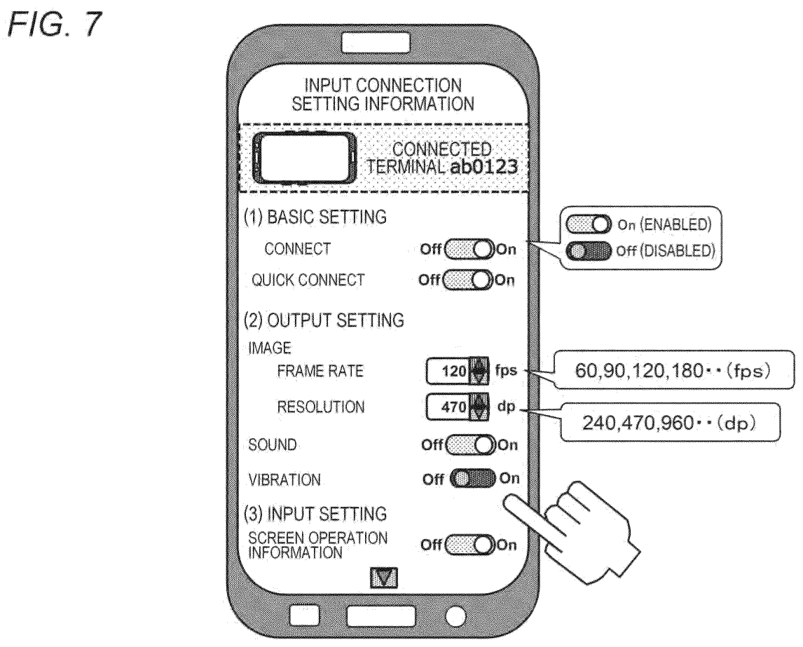

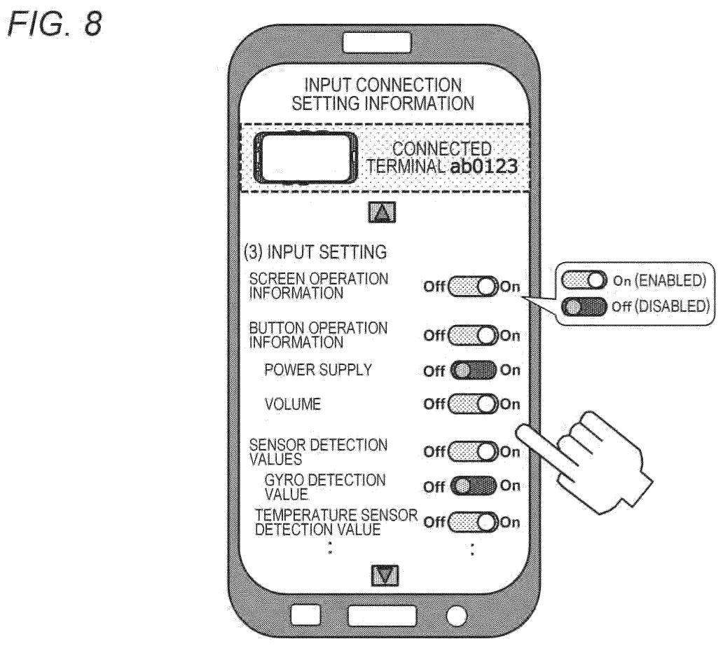

Next, an example of a UI for inputting connection setting information will be described with reference to FIGS. 7 and 8.

When the terminal to be connected is determined, a UI for inputting connection settings for the terminal to be connected is displayed on the terminal as illustrated in FIGS. 7 and 8. The UI can be displayed on any of the user operation terminal 20 and the user non-operation terminal 30. Note that the example illustrated in FIGS. 7 and 8 is an example of the UI displayed on the user non-operation terminal 30.

The connection settings to be made using the UI are classified into the following categories.
(1) Basic setting
(2) Output setting
(3) Input setting

As illustrated in FIG. 7, “(1) Basic setting” includes setting items such as
a setting of enabling (On) or disabling (Off) connection, and
a setting of enabling (On) or disabling (Off) quick connection.

By enabling (On) the connection, mutual communication with the terminal to be connected via the communication path becomes possible.

By disabling (Off) the connection, mutual communication with the terminal to be connected via the communication path is cut off.

Note that “quick connection” is a connection setting for automatically enabling the communication path between the two terminals by inserting a connection cable into both the user operation terminal 20 and the user non-operation terminal 30.

By enabling (On) the quick connection and inserting the connection cable into the terminal and the terminal to be connected, the communication path between the two terminals is automatically enabled, and mutual communication via the communication paths becomes possible.

In a case where the quick connection is disabled (Off), on the other hand, even if the connection cable is inserted into the terminal and the terminal to be connected, the communication path between the two terminals is not automatically enabled, and in order to enable the communication path, it is necessary to perform processing for enabling (On) a “connection” item. “(2) Output setting” includes setting items for setting whether or not to output data from the terminal and an output mode.

Note that the example illustrated in FIG. 7 is an example of a UI displayed on the user non-operation terminal 30, and “(2) Output setting” includes items for setting data to be output from the user non-operation terminal 30 to the user operation terminal 20 via the communication path.

Note that “(2) Output setting” of the UI displayed on the user operation terminal 20 includes items for setting data to be output from the user operation terminal 20 to the user non-operation terminal 30 via the communication path.

“(2) Output setting” of the UI displayed on the user non-operation terminal 30 illustrated in FIG. 7 includes the following setting items.
Setting items of a frame rate and resolution of images
Whether or not to output sound
Whether or not to output vibration

Note that images are assumed to be output, and there is no setting item as to whether or not to output images.

Items that can be set for images are the frame rate and the resolution.

For example, the frame rate can be set by selecting a frame rate of images that can be displayed on the user operation terminal 20. For example, frame rates such as 60 fps, 90 fps, 120 fps, and 180 fps can be set.

In addition, the resolution can be set by selecting a resolution of images that can be displayed on the user operation terminal 20. For example, a resolution such as 240 dp, 470 dp, and 960 dp can be set.

It is possible to set whether or not to output sound, and an output setting (On) is made in a case where sound information generated by executing the app on the user non-operation terminal 30 side is to be output to the user operation terminal 20, and an output stop setting (Off) is made in a case where the sound information is not to be output.

Whether or not to output can also be set for vibration, and an output setting (On) is made in a case where vibration information generated by executing the app on the user non-operation terminal 30 side is to be output to the user operation terminal 20, and an output stop setting (Off) is made in a case where the vibration information is not to be output.

“(3) Input setting” includes setting items for setting whether or not to input data to the terminal and an input mode.

Note that the example illustrated in FIGS. 7 and 8 is an example of the UI displayed on the user non-operation terminal 30, and “(3) Input setting” includes items for setting data to be input from the user operation terminal 20 to the user non-operation terminal 30 via the communication path.

“(3) Input setting” of the UI displayed on the user operation terminal 20 includes items for setting data to be input from the user non-operation terminal 30 to the user operation terminal 20 via the communication path.

“(3) Input setting” of the UI displayed on the user non-operation terminal 30 illustrated in FIGS. 7 and 8 includes the following setting items.
Whether or not to input screen operation information
Whether or not to input button operation information
Whether or not to input power supply and volume operation information as input presence/absence setting items for individual buttons
Whether or not to input sensor detection values
Whether or not to input sensor detection values of a gyro, a temperature sensor, and the like as input settings of detected values of individual sensors

In a case where detection information regarding the user's touch operations (taps, flicks, swipes, and the like) on the screen of the user operation terminal 20 is to be input from the user operation terminal 20 to the user non-operation terminal 30 via the communication path, the setting as to whether or not to input screen operation information is set to (On). In a case where no input is made, (Off) is set.

In a case where detection information regarding the user's operations on the buttons of the user operation terminal 20 is to be input from the user operation terminal 20 to the user non-operation terminal 30 via the communication path, the setting as to whether or not to input button operation information is set to (On). In a case where no input is made, (Off) is set.

Furthermore, with respect to the buttons, individual setting of each button is possible, and whether or not to input operation information regarding individual operation units such as a power supply and a volume can be individually set.

The same holds for the sensor detection values, that is, in a case where detected values of the sensors of the user operation terminal 20 are to be input from the user operation terminal 20 to the user non-operation terminal 30 via the communication path, the setting as to whether or not to input sensor detection values is set to (On). In a case where no input is made, (Off) is set.

Furthermore, whether or not to input individual sensor detection values of the gyro, the temperature sensor, and the like can also be individually set.

As described above, in the processing for connecting the user operation terminal 20 and the user non-operation terminal 30 to each other, presence or absence and the modes of information input and output between the terminals can be set using the UI illustrated in FIGS. 7 and 8.

Various types of data are transmitted and received between the user operation terminal 20 and the user non-operation terminal 30 via the communication path in accordance with the setting information.

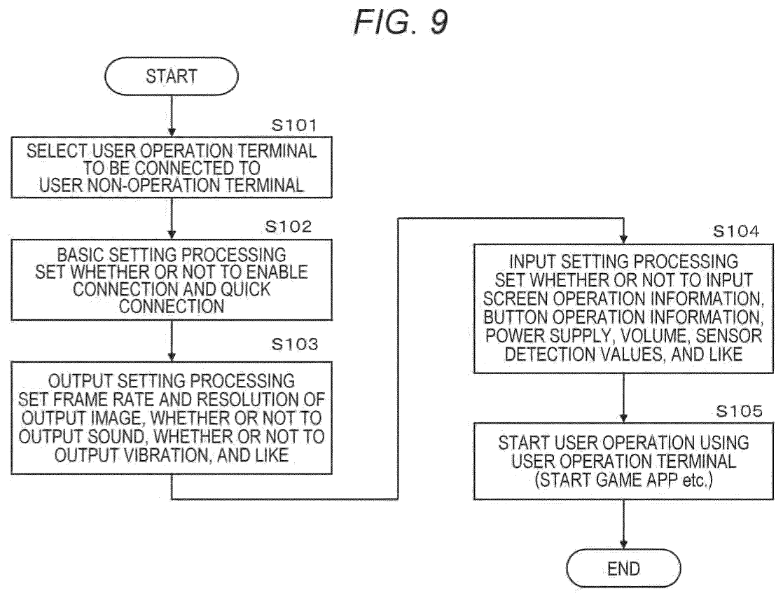

Next, a processing sequence when the user operation terminal 20 and the user non-operation terminal 30 are connected to each other will be described with reference to a flowchart illustrated in FIG. 9. That is, this is a processing sequence in a case where a process for selecting a terminal to be connected performed using the UIs illustrated in FIGS. 6 to 8 and a process for setting information input and output between the terminals are executed.

Note that a flow illustrated in FIG. 9 is a processing sequence for displaying and executing the UIs illustrated in FIGS. 6 to 8 in the user non-operation terminal 30, which is the information processing apparatus in the present disclosure. The processing sequence is executed under the control of the control unit (data processing unit) of the user non-operation terminal 30 in accordance with a program stored in a storage unit of the user non-operation terminal 30. The control unit (data processing unit) includes a processor such as a CPU having a program execution function, for example, and can perform the processes according to the flow through processing for executing the program using the processor.

Processing in each of steps of the flow illustrated in FIG. 9 will be sequentially described hereinafter.

### (Step S101)

First, in step S101, the user operation terminal 20 to be connected to the user non-operation terminal 30 is selected.

This processing is a processing step for displaying and executing the UI described above with reference to FIG. 6 on the display unit of the user non-operation terminal 30.

For example, in a case where a plurality of terminals connectable by WLAN (wireless LAN) is detected, a plurality of connectable terminal candidates is displayed as described with reference to FIG. 6. The user selects one of the displayed detected terminals as the terminal to be connected.

Note that, for example, in a case where wired connection such as USB or LAN is established, one terminal connected to the cable is determined as the terminal to be connected, and the processing in step S101 is omitted without displaying the selection screen illustrated in FIG. 6.

### (Step S102)

Next, in step S102, the basic setting of connection with the connected terminal is performed.

Specifically, as described above with reference to FIG. 7,
the setting of enabling (On) or disabling (Off) connection, and
the setting of enabling (On) or disabling (Off) quick connection
are performed.

### (Step S103)

Next, in step S103, the output setting for the connected terminal is performed.

Specifically, as described above with reference to FIG. 7,
the setting items of the frame rate and the resolution of images,
whether or not to output sound, and
whether or not to output vibration
are determined.

### (Step S104)

Next, in step S104, the input setting for the connected terminal is performed.

Specifically, as described above with reference to FIGS. 7 and 8,
whether or not to input screen operation information,
whether or not to input button operation information,
whether or not to input the power supply and volume operation information as input presence/absence setting items for individual buttons,
whether or not to input sensor detection values, and
whether or not to input from the gyro, the temperature sensor, and the like as input setting of the detected values of the individual sensors.

### (Step S105)

When all the settings are completed in steps S101 to S104, next, in step S105, the user holds the user operation terminal 20 and executes an app such as a game app.

With such a processing mode, data set by the user is transmitted and received between the user operation terminal 20 and the user non-operation terminal 30.

In addition, data processing with a large processing load such as the processing for generating a 3D image is executed by the user non-operation terminal 30, and a generated image as a processing result is transmitted to the user operation terminal 20 and displayed on the display unit of the user transmission terminal 20.

Since the user operation terminal 20 need not execute data processing with a large processing load such as the processing for generating a 3D image, the temperature rise of the user operation terminal 20 is reduced.

As a result, the user can play the game for a long time while holding the user operation terminal 20 in his/her hands.

The user non-operation terminal 30, however, continuously executes data processing with a large processing load, such as 3D image generation processing, and in some cases, the temperature might rise to a level where it is dangerous for the user to touch.

Processing assuming such a situation, that is, response processing in a case where the temperature of the user non-operation terminal 30 rises, will be described.

### 5. Detection of Change in Temperature of User Terminal and Processing for Outputting Warning

Next, detection of a change in the temperature of the user terminal and processing for outputting an alarm will be described.

In a case where the user operation terminal 20 and the user non-operation terminal 30 are connected to each other by the above-described processing and the user 10 executes an app of a game or the like while holding the user operation terminal 20 in his/her hands, the user non-operation terminal 30 executes data processing with a large processing load such as the processing for generating a 3D image.

If such a state continues for a long time, the temperature of the user non-operation terminal 30 rises, and in some cases, there is a possibility that the temperature rises to a level where the user cannot touch the user non-operation terminal 30. In such a case, even if the user desires to use (operate) the user non-operation terminal 30, the user cannot use (operate) the user non-operation terminal 30.

Specifically, for example, if there is an incoming call to the user non-operation terminal 30 while the user 10 is holding the user operation terminal 20 and executing a game, the user needs to operate the user non-operation terminal 30. There is a possibility, however, that the user non-operation terminal 30 is too hot for the user to operate and answer the phone.

In addition, in a case where communication is interrupted or in a case where it is necessary to operate the user non-operation terminal 30 to change communication settings or the like, the user non-operation terminal 30 cannot be operated if it is too hot.

An embodiment described hereinafter is an embodiment for coping with such a situation.

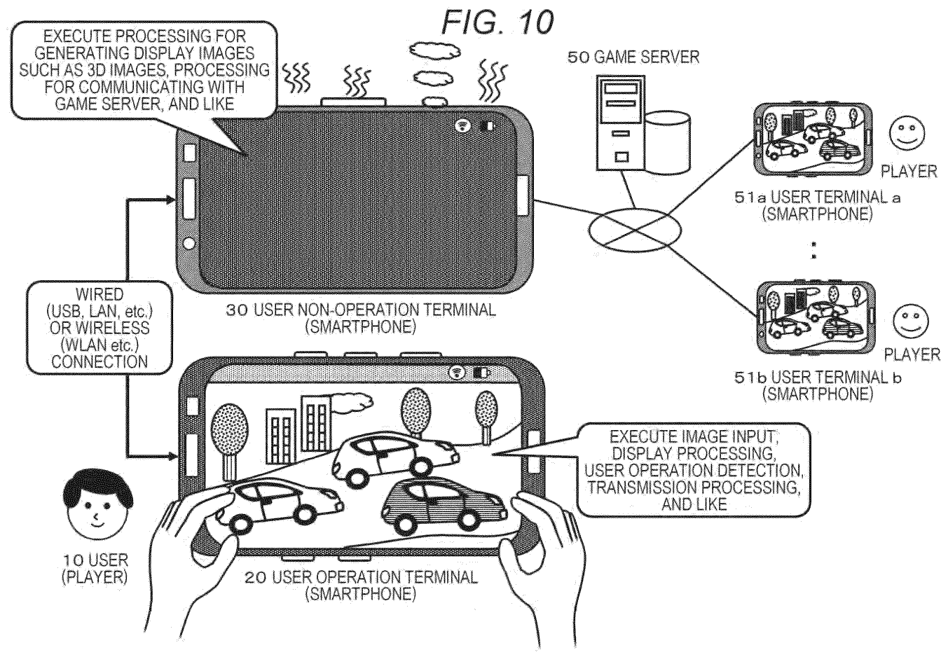

FIG. 10 illustrates a state in which the user operation terminal 20 and the user non-operation terminal 30 are connected to each other, and the user 10 executes the game app while holding the user operation terminal 20 in his/her hands.

The user non-operation terminal 30 executes data processing according to input information, such as user operation information, setting information, and sensor detection information, in the user operation terminal 20, that is, for example, the processing for generating a 3D image, the processing for generating sound information, and the vibration information, and transmits execution results (image, sound, and vibration information and the like) information to the user operation terminal 20 via the communication path.

Furthermore, the user non-operation terminal 30 also executes communication with the game server 50 via an external network such as the Internet, executes processing for generating output information regarding an image, a sound, and vibration according to operation information regarding other players and chat information, and transmits the generated image, sound, and vibration information and the like to the user operation terminal 20 via the communication path.

As described above, a processing load of the data processing executed by the user non-operation terminal 30 is large, and therefore the temperature of the terminal tends to be high.

Note that many smartphones have a control function for preventing an excessive temperature rise, and if the temperature becomes equal to or higher than the predetermined temperature, for example, control for forcibly decreasing the data processing speed of the CPU or the like is executed.

Note that, for example, even at a temperature of about 45° C., there is a possibility that a low-temperature burn occurs if the hands of the user touch for a long time.

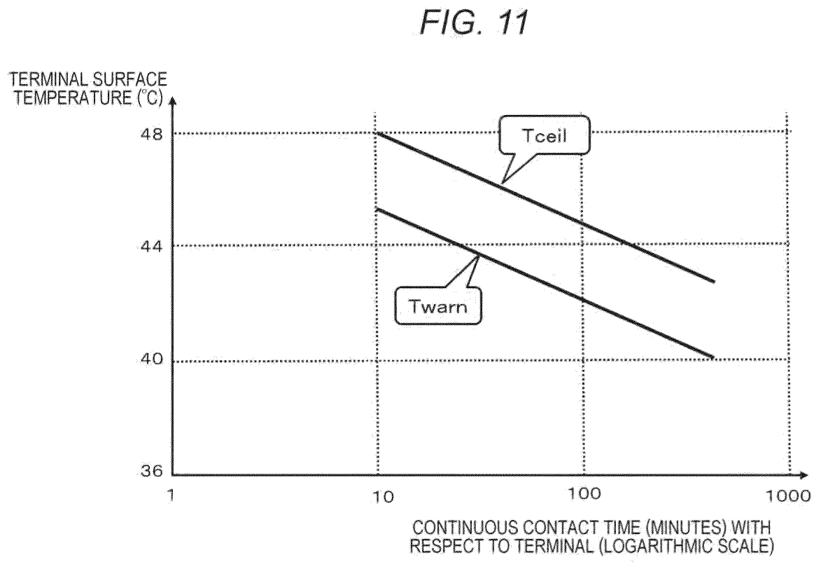

A graph illustrated in FIG. 11 is a graph in which terminal surface temperature is set on a vertical axis and continuous contact time with respect to the terminal is set on the horizontal axis, and is a graph illustrating a line (Twarn) on which it is determined that a warning is necessary and a line (Tceil) on which it is necessary to stop the use (operation).

As described above, even at a temperature of about 45° C., there is a possibility of a low-temperature burn when used (operated) for a long time, and it is necessary to give a warning or the like to the user.

An embodiment described hereinafter is an embodiment in which the detection of the temperature rise of the user terminal and the processing for outputting a warning are performed.

In the present embodiment, three reference according to the terminal temperature, that is, reference 1, reference 2, and reference 3, are set, and whether to permit or prohibit the use of the terminal and what kind of warning is to be output are specified in these three reference units, and processing according to the specification is executed.

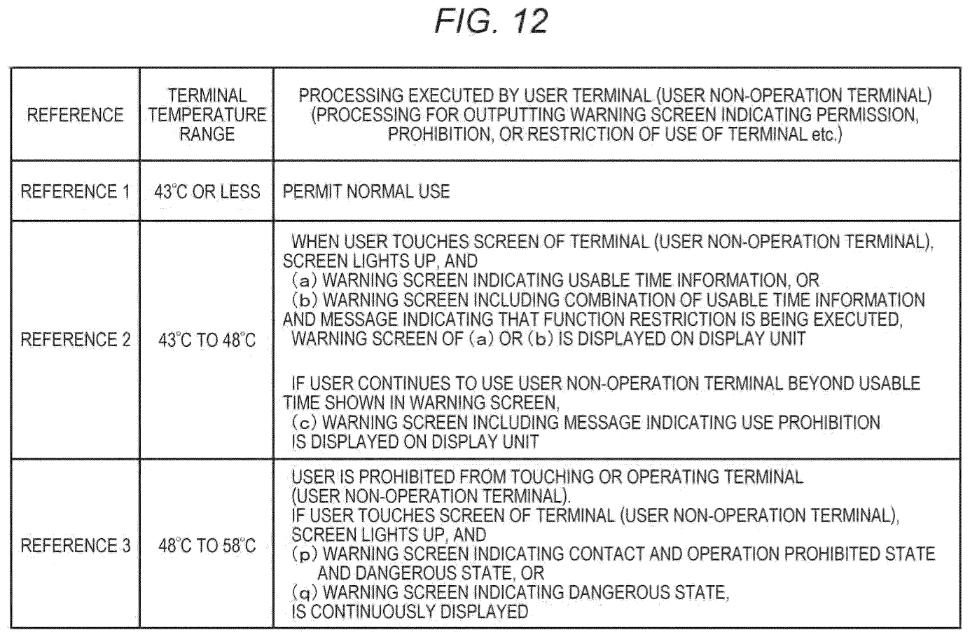

With reference to FIG. 12, the three references according to the terminal temperature, that is, reference 1, reference 2, and reference 3, and the processing according to these three references will be described.

Reference 1, reference 2, and reference 3 are the following temperature ranges.
(Reference 1) A temperature range in which normal terminal operations can be performed,
(Reference 2) A temperature range in which there is no risk of a low-temperature burn if a terminal operation is performed within a predetermined time, and
(Reference 3) A temperature range in which the temperature is higher than or equal to reference 2, but a high-temperature burn does not occur immediately when the terminal is touched,

Specifically, references 1 to 3 are associated with the terminal temperature as follows.
Reference 1=Terminal temperature is 43° C. or lower
Reference 2=Terminal temperature is 43° C. to 48° C.
Reference 3=Terminal temperature is 48° C. to 58° C.

Processing corresponding to each of references 1 to 3 corresponding to different temperatures is processing illustrated in FIG. 12. Note that the processing corresponding to each of the references illustrated in FIG. 12 is processing in the user non-operation terminal 30. The user is executing an app of a game or the like on the user operation terminal 20, and nothing is usually displayed on the screen of the user non-operation terminal 30.

Details of processing executed by the control unit of the user non-operation terminal 30 in a case where the temperature of the user non-operation terminal 30 is in each of references 1 to 3 will be described hereinafter with reference to FIG. 12.

(Reference 1)=Processing executed in a case where the terminal temperature is 43° C. or lower

In this case, the control unit of the user non-operation terminal 30 permits the user to use the terminal (user non-operation terminal 30) as usual.

In this (reference 1) state, the temperature of the user non-operation terminal 30 is 43° C. or lower. In this temperature range, user operations can be executed without any problem, and normal use of the terminal (user non-operation terminal 30) is permitted.

In this case, the control unit of the user non-operation terminal 30 continues a state in which nothing is displayed on the screen of the user non-operation terminal 30 (black screen).

In this state, in a case where the user desires to use (operate) the user non-operation terminal 30 for telephone or other purposes, for example, the user can use (operate) the user non-operation terminal 30 without any problem.

(Reference 2)=Processing executed in a case where the terminal temperature is 43° C. to 48° C.

In this case, the control unit of the user non-operation terminal 30 lights up the screen when the user touches the screen of the terminal (user non-operation terminal 30), and displays, on the display unit,
(a) a warning screen indicating usable (operable) time information, or
(b) a warning screen including a combination of usable (operable) time information and a message indicating that function restriction is being executed,
that is, one of the warning screens (a) and (b) described above.

In this (reference 2) state, in a case where the temperature of the terminal (user non-operation terminal 30) is 43° C. to 48° C. and the user holds the user non-operation terminal 30 in his/her hands, there is no problem as long as it is in a short time, but there is a possibility of a low-temperature burn if the user touches the terminal for a long time.

In order to notify the user of this, as described above, the control unit of the user non-operation terminal 30 displays, on the display unit,
(a) the warning screen indicating usable (operable) time information, or
(b) the warning screen including a combination of usable (operable) time information and a message indicating that function restriction is being executed,
that is, one of the warning screens (a) and (b) described above.

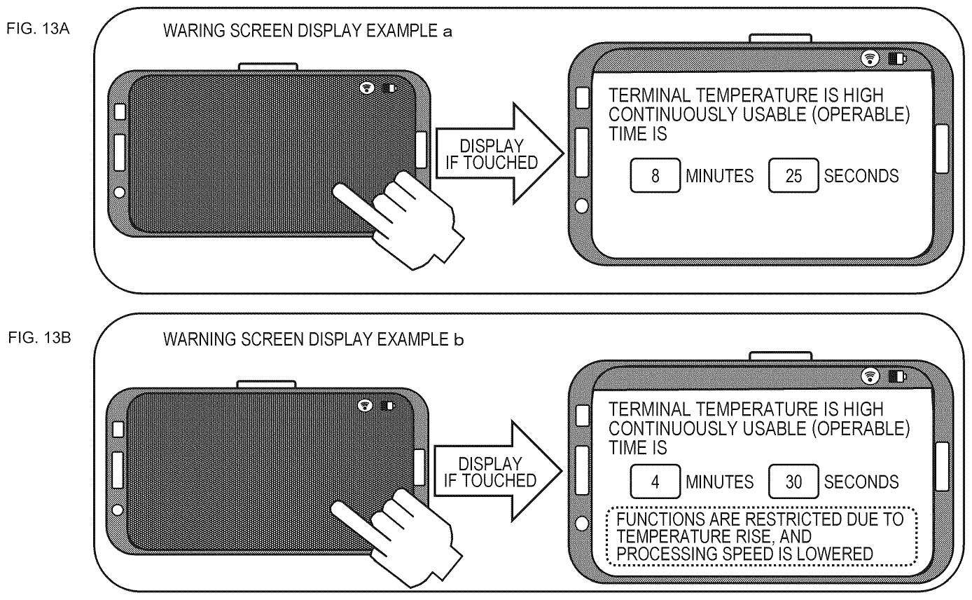

FIG. 13 illustrates examples of the warning screens displayed on the display unit of the user non-operation terminal 30.
(a) Warning screen display example a in FIG. 13 is an example of the warning screen indicating usable (operable) time information.
(b) Warning screen display example b in FIG. 13 is an example of the warning screen including a combination of usable (operable) time information and a message indicating that function restriction is being executed.

In both (a) and (b) in FIG. 13, for example, if the user touches the screen, a warning screen is displayed.

As a result, the user can learn that the temperature of the terminal (user non-operation terminal 30) is high and the user cannot use (operate) the terminal for a long time or that the function restriction is being executed.

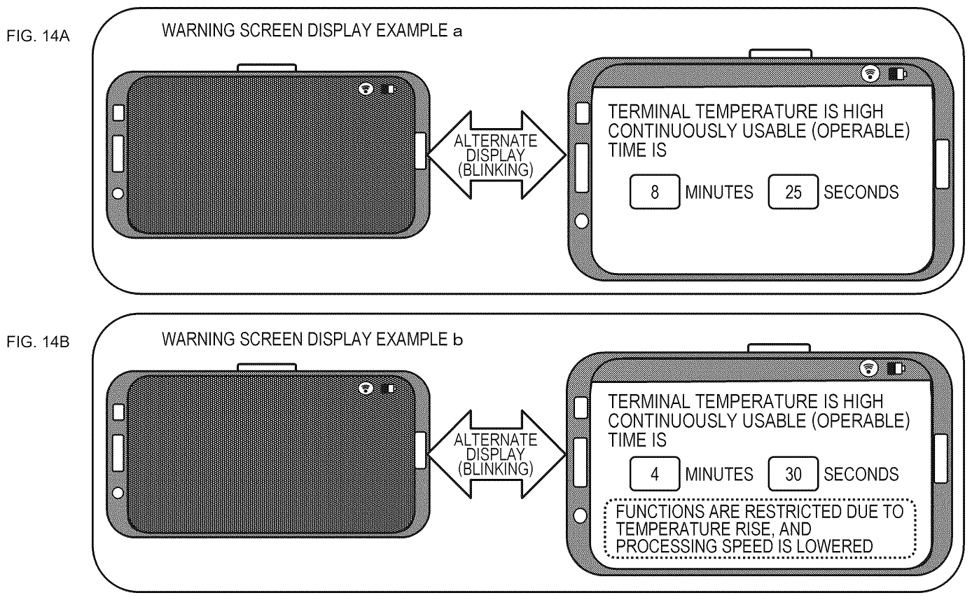

Note that the examples illustrated in FIG. 13 are examples in which a warning screen is displayed if the user touches the screen, but, for example, as illustrated in FIG. 14, even in a state where the user does not touch the screen, a non-display screen (black screen) and a warning screen may be displayed alternately as if the screen is blinking on condition that the temperature of the user non-operation terminal 30 becomes the temperature of Reference 2(43 ° C. to 48° C.).

Note that in a case where the temperature of the user non-operation terminal 30 reaches the temperature of Reference 2 (43° C. to 48° C.), the control unit of the user non-operation terminal 30 executes functional restriction such that the temperature of Reference 2(43 ° C. to 48° C.) is not exceeded. Specifically, for example, processing of reducing the processing speed of the CPU is performed.

The usable (operable) time displayed on the warning screen is calculated by the control unit of the user non-operation terminal 30.

For example, time taken to cause a possibility of a low-temperature burn in a case where the user continues to use the user non-operation terminal 30 at the current temperature is calculated. Specifically, for example, it is the time on the line (Twarn) on which it is determined that the warning of the graph illustrated in FIG. 11 is necessary.

In addition, in a case where the user continues to use the user non-operation terminal 30 beyond the usable (operable) time displayed on the warning screen, the control unit of the user non-operation terminal 30 displays
(c) a warning screen including a message indicating operation prohibition
on the display unit of the user non-operation terminal 30.

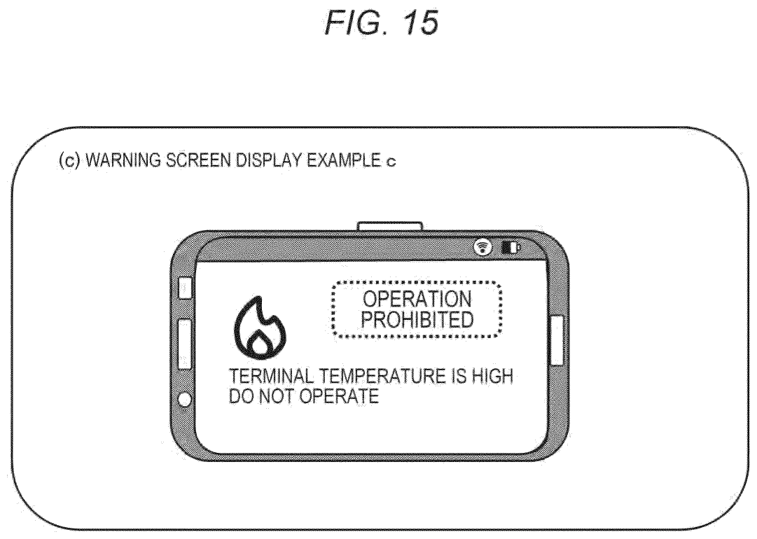

FIG. 15 illustrates a display example of this warning screen.

The warning screen illustrated in FIG. 15 is displayed on the display unit of the user non-operation terminal 30. Alternatively, the warning screen may be displayed in a case where it is detected that user operation time of the user non-operation terminal 30 exceeds the usable (operable) time.

In addition, the processing for displaying a warning screen may be executed as temporary display processing, or a warning screen may be continuously displayed.

Note that, during an operation prohibition period of the user non-operation terminal 30, the control unit of the user non-operation terminal 30 may perform the following control and message display.

That is, during the operation prohibition period of the user non-operation terminal 30, control is performed such that the user non-operation terminal 30 can be operated (remotely operated) via the user operation terminal 20 connected to the user non-operation terminal 30.

Furthermore, in addition to this control, a message indicating that the user non-operation terminal 30 can be operated via the user operation terminal 20 is displayed.

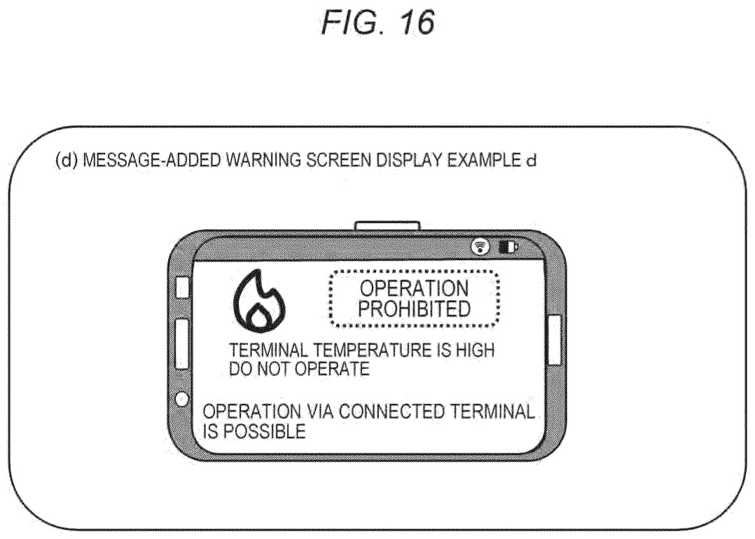

FIG. 16 illustrates an example of this message display screen.
(d) Message display example d illustrated in FIG. 16 is a warning screen in which the following message,

“Operation via connected terminal is possible”,
is additionally displayed along with “(c) the warning screen including a message indicating operation prohibition” illustrated in FIG. 15.

The warning screen illustrated in FIG. 16 may also be displayed in a case where the user touches the display unit of the user non-operation terminal 30, or in a case where it is detected that the user operation time of the user non-operation terminal 30 exceeds the usable (operation) time.

The processing for displaying a warning screen may be executed as temporary display processing, or a warning screen may be continuously displayed.

By viewing the message, the user can learn that the user non-operation terminal 30 can be operated via the user operation terminal 20.

Note that, as a specific example in which the user non-operation terminal 30 is operated via the user operation terminal 20, for example, there is processing for using (operating) the user operation terminal 20 to answer a call when a call to the user non-operation terminal 30 arrives. The user can answer a call in response to an incoming call of the user non-operation terminal 30 by using (operating) the user operation terminal 20 without touching the user non-operation terminal 30.

Note that the control unit of the user non-operation terminal 30 transmits a call screen generated by a call app similarly to the game screen and call voice to the user operation terminal 20 via the communication path.

In addition, the user's voice received by the user operation terminal 20 is also transmitted to the user non-operation terminal 30 via the communication path under the control of the control unit on a user operation terminal 20 side, and is further transmitted to a talk partner through processing by the call app on the user non-operation terminal 30.
(Reference 3)=Processing executed in a case where the terminal temperature is 48° C. to 58° C.

In this case, the control unit of the user non-operation terminal 30 prohibits the user from touching or operating the terminal (user non-operation terminal) as usual.

When the user touches the screen of the terminal (user non-operation terminal 30), the screen is lit up, and
(p) a warning screen indicating a contact and operation prohibited state and a dangerous state, or
(q) a warning screen indicating a dangerous state,
that is, one of the warning screens (p) and (q) described above, is displayed on the display unit.

In this (reference 3) state, the temperature of the terminal (user non-operation terminal 30) is 48° C. to 58° C., and there is a possibility of a low-temperature burn if the user holds the user non-operation terminal 30 in his/her hands even for a short period of time.

In order to notify the user of this, as described above, the control unit of the user non-operation terminal 30 displays, on the display unit,
(p) the warning screen indicating the contact and operation prohibited state and the dangerous state, or
(q) the warning screen indicating the dangerous state, that is, one of the warning screens (p) and (q) described above.

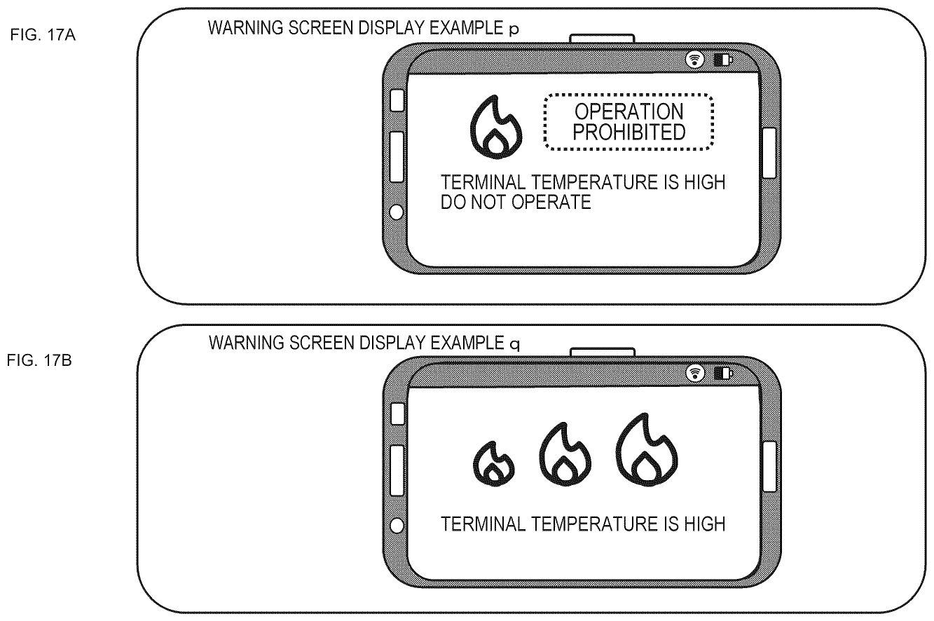

FIG. 17 illustrates examples of the warning screens displayed on the display unit of the user non-operation terminal 30.
(p) Warning screen display example p in FIG. 17 is the warning screen indicating that the user non-operation terminal 30 is in the contact and operation prohibited state and in the dangerous state.
(q) Warning screen display example q in FIG. 17 is the warning screen indicating that the user non-operation terminal 30 is in the dangerous state.

By viewing these warning screens, the user can learn that the temperature of the terminal (user non-operation terminal 30) is extremely high and that the terminal is in the dangerous state and cannot be used (operated).

Note that the warning screens illustrated in FIG. 17 are displayed when the user touches the display unit of the user non-operation terminal 30. Alternatively, the warning screens may be continuously displayed from a time point when it is detected that the temperature of the terminal (user non-operation terminal 30) has reached the temperature of Reference 3(48 ° C. to 58° C.).

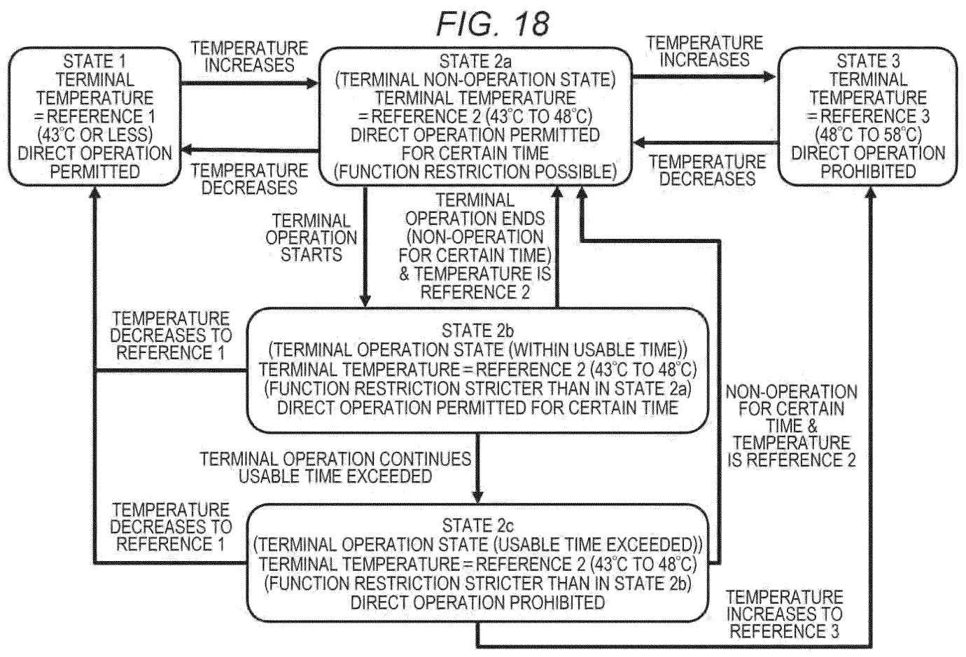

Next, a state transition accompanying changes in the temperature of the user non-operation terminal 30 and user operations will be described with reference to FIG. 18.

As illustrated in FIG. 18, a state of the user non-operation terminal 30 is classified into one of following five states.
State 1
State 2a
State 2b
State 2c
State 3

State 1 is a state in which the temperature of the terminal (user non-operation terminal 30) is reference 1(43 ° C. or lower).

This state 1 can occur in both a state in which the user is operating the terminal (user non-operation terminal 30) and a state in which the user is not operating the terminal.

In a case where the state of the user non-operation terminal 30 is “state 1”, no warning screen or message is displayed on the display unit of the user non-operation terminal 30, and use (operation) of the user non-operation terminal 30 is permitted.

For example, processing in which the user directly uses (operates) the user non-operation terminal 30 to execute a phone call, a mail, or another app is permitted.

State 2a, state 2b, and state 2c are all states in which the temperature of the terminal (user non-operation terminal 30) is reference 2(43 ° C. to 48° C.).

State 2a is a state set in a case where the terminal (user non-operation terminal 30) has transitioned from the temperature of reference 1(43 ° C. or lower) or the temperature of reference 3 (48° C. to 58° C.) to the temperature of reference 2(43 ° C. to 48° C.).

State 2b is a state in which after the terminal (user non-operation terminal 30) transitions to the temperature of reference 2(43 ° C. to 48° C.), the user is operating the terminal (user non-operation terminal 30), and the user operation time has not exceeded the predetermined usable (operation) time.

State 2c is a state in which the user is continuously operating the terminal (user non-operation terminal 30) from the state of state 2b, and the continuous user operation time has exceeded the predetermined usable (operation) time.

In a case where the state of the user non-operation terminal 30 is “state 2a”, the warning screen described with reference to FIG. 13 or FIG. 14, namely
(a) the warning screen indicating usable (operable) time information, or
(b) the warning screen including a combination of usable (operable) time information and a message indicating that function restriction is being executed,
that is, one of the warning screens (a) and (b) described above, is displayed on the display unit of the user non-operation terminal 30.

That is, in a case where the state of the user non-operation terminal 30 is in “state 2a”, as described above with reference to FIGS. 12 to 14 and the like, the control unit of the user non-operation terminal 30 calculates, as continuously usable (operable) time, time taken to cause a possibility of a low temperature burn in a case where the user continues to use the user non-operation terminal 30 at the current temperature of the user non-operation terminal 30. Specifically, for example, the time on the line (Twarn) on which it is determined that the warning of the graph illustrated in FIG. 11 is necessary is calculated as the continuously usable (operable) time, and the calculated time is displayed on the warning screen described with reference to FIG. 13 or 14.

As described above, in a case where the state of the user non-operation terminal 30 is “state 2a”, direct use (operation) within the continuously usable (operable) time determined by the control unit of the user non-operation terminal 30 is permitted.

There is a case, however, where the function of the user non-operation terminal 30 is restricted.

A case where the state of the user non-operation terminal 30 becomes state 2b is a case where after the terminal (user non-operation terminal 30) transitions to the temperature of reference 2(43 ° C. to 48° C.), the user is operating the terminal (user non-operation terminal 30), and the user operation time has not exceeded the predetermined usable (operation) time.

In a case where the state of the user non-operation terminal 30 is “state 2b”, as in the case of “state 2a”, the warning screen described with reference to FIG. 13 or FIG. 14, namely
(a) the warning screen indicating usable (operable) time information, or
(b) the warning screen including a combination of usable (operable) time information and a message indicating that function restriction is being executed,
that is, one of the warning screens (a) and (b) described above, is displayed on the display unit of the user non-operation terminal 30.

Even in “state 2b”, therefore, the use (operation) of the user non-operation terminal 30 is permitted only within the predetermined continuously usable (operable) time.

The function of the user non-operation terminal 30, however, is more restricted than in “state 2a”.

A case where the state of the user non-operation terminal 30 becomes state 2c is a case where after the terminal (user non-operation terminal 30) transitions to the temperature of reference 2(43 ° C. to 48° C.), the user has been continuously using (operating) the terminal (user non-operation terminal 30) longer than the predetermined usable (operation) time.

In a case where the state of the user non-operation terminal 30 is “state 2c”, the warning screen described above with reference to FIG. 15, namely
(c) the warning screen including a message indicating operation prohibition,
or the warning screen described with reference to FIG. 16, namely
(d) the warning screen in which a message, “Operation the connected terminal is possible”, is further added to the message indicating operation prohibition,
that is, one of these warning screens (c) and (d), is displayed on the display unit of the user non-operation terminal 30.

In this “state 2c”, the use (operation) of the user non-operation terminal 30 is prohibited.

Note that in a case where the user operation is continued in this “state 2c”, the function of the user non-operation terminal 30 is even more restricted than in “state 2b”.

State 3 is a state in which the temperature of the terminal (user non-operation terminal 30) is reference 3(48 ° C. to 58° C.).

This state 3 can occur in both a state in which the user is operating the terminal (user non-operation terminal 30) and a state in which the user is not operating the terminal.

In a case where the state of the user non-operation terminal 30 is “state 3”, one of the warning screens described above with reference to FIG. 17, namely
(p) the warning screen indicating that the user non-operation terminal 30 is in the contact and operation prohibited state and in the dangerous state or
(q) the warning screen indicating that the user non-operation terminal 30 is in the dangerous state
, that is, one of these warning screens, is displayed on the display unit of the user non-operation terminal 30.

In “state 3”, the use (operation) of the user non-operation terminal 30 is thus prohibited.

Note that in a case where the user operation is continued in this “state 3”, the function of the user non-operation terminal 30 is even more restricted than in “state 2b”.

The state of the user non-operation terminal 30 is set to one of these five states (state 1, state 2a, state 2b, state 2c, and state 3), and transitions to a different state if a predetermined state transition condition occurs in a certain state.

Conditions of state transitions will be described hereinafter.

(Transition from State 1 to State 2a)

The transition from state 1 to state 2a occurs in a case where the temperature of the terminal (user non-operation terminal 30) rises from reference 1(43 ° C. or lower) to reference 2(43° C. to 48° C.).

This transition occurs regardless of whether or not the user non-operation terminal 30 is being operated. For example, in a case where a processing load of the user non-operation terminal 30 increases, such as a case where a load caused by the generation of an image (a 3D image or the like) to be output to the user operation terminal 20 connected to the user non-operation terminal 30 increases, or a case where user operations on the user operation terminal 20 increase, the temperature of the terminal (user non-operation terminal 30) increases from reference 1(43° C. or lower) to reference 2(43° C. to 48° C.), and the transition from state 1 to state 2 occurs.

(Transition from State 1 to State 2a)

The transition from state 2a to state 1 occurs in a case where the temperature of the terminal (user non-operation terminal 30) decreases from reference 2(43° C. to 48° C.) to reference 1(43 ° C. or lower).

This transition occurs regardless of whether or not the user non-operation terminal 30 is being operated. For example, in a case where the processing load of the user non-operation terminal 30 decreases, such as a case where the load caused by the generation of an image (a 3D image or the like) to be output to the user operation terminal 20 connected to the user non-operation terminal 30 decreases, or a case where user operations on the user operation terminal 20 decrease, the temperature of the terminal (user non-operation terminal 30) decreases from reference 2(43° C. to 48° C.) to reference 1(43° C. or lower), and the transition from state 2a to state 1 occurs.

(Transition from State 2a to State 3)

The transition from state 2a to state 3 occurs in a case where the temperature of the terminal (user non-operation terminal 30) rises from reference 2(43° C. to 48° C.) to reference 3(48° C. to 58° C.).

This transition occurs regardless of whether or not the user non-operation terminal 30 is being operated. For example, in a case where the processing load of the user non-operation terminal 30 increases, such as a case where the load caused by the generation of an image (a 3D image or the like) to be output to the user operation terminal 20 connected to the user non-operation terminal 30 further increases, or a case where user operations on the user operation terminal 20 further increase, the temperature of the terminal (user non-operation terminal 30) increases from reference 2(43 ° C. to 48° C.) to reference 3(48 ° C. to 58° C.), and the transition from state 2a to state 3 occurs.

(Transition from State 3 to State 2a)

The transition from state 3 to state 2a occurs in a case where the temperature of the terminal (user non-operation terminal 30) decreases from reference 3(48° C. to 58° C. to reference 2(43° C. to 48° C.).

This transition occurs regardless of whether or not the user non-operation terminal 30 is being operated. For example, in a case where the processing load of the user non-operation terminal 30 decreases, such as a case where the load caused by the generation of an image (a 3D image or the like) to be output to the user operation terminal 20 connected to the user non-operation terminal 30 decreases, or a case where user operations on the user operation terminal 20 decrease, the temperature of the terminal (user non-operation terminal 30) decreases from reference 3(48° C. to 58° C. to reference 2(43° C. to 48° C.), and the transition from state 3 to state 2a occurs. (Transition from State 2a to State 2b)

The transition from the state 2a to the state 2b occurs in a case where the user starts to use (operate) the user non-operation terminal 30 and the use (operation) time is within the continuously usable (operable) time in a period in which the temperature of the terminal (user non-operation terminal 30) is within the range of reference 2(43° C. to 48° C.).

This transition occurs, for example, in a case where the user stops the operation of the user operation terminal 20 connected to the user non-operation terminal 30 and starts to use (operate) the user non-operation terminal 30, that is, for example, in a case where the user operates the user non-operation terminal 30 to start a direct operation of the user non-operation terminal 30, such as execution of a phone call, a mail, or another app.

Note that in a case where the temperature of the terminal (user non-operation terminal 30) is within the range of reference 2(43° C. to 48° C.), as described above with reference to FIGS. 12 to 14, the continuously usable (operable) time is calculated in advance.

That is, as described above, the control unit of the user non-operation terminal 30 calculates, as the continuously usable (operable) time, time taken to cause a possibility of a low temperature burn in a case where the user continues to use the user non-operation terminal 30 at the current temperature of the user non-operation terminal 30.

Specifically, for example, the time on the line (Twarn) on which it is determined that the warning of the graph illustrated in FIG. 11 is necessary is used.

As described above, the state 2b is a state set in a case where the continuous use (operation) time after a start of use (operation) of the user non-operation terminal 30 does not exceed the determined continuously usable (operable) time.

(Transition from State 2b to State 2a)

The transition from the state 2b to the state 2a occurs in a case where the user's use (operation) time of the terminal (user non-operation terminal 30) ends within the continuously usable (operable) time in a period in which the temperature of the terminal (user non-operation terminal 30) is within the range of reference 2(43° C. to 48° C.) and, at this point in time, the temperature of the terminal (user non-operation terminal 30) is within the range of reference 2(43° C. to 48° C.).

(Transition from State 2b to State 1)

The transition from state 2b to state 1 occurs in a case where, in state 2b, the user's use (operation) time of the terminal (user non-operation terminal 30) ends within the continuously usable (operable) time and, at a time of the ending, the temperature of the terminal (user non-operation terminal 30) is within the range of reference 1(43° C. or lower).

(Transition from State 2b to State 2c)

The transition from the state 2b to the state 2c occurs in a case where the user starts to use (operate) the terminal (user non-operation terminal 30) in a period in which the temperature of the terminal (user non-operation terminal 30) is within the range of reference 2(43° C. to 48° C.) and the use (operation) time exceeds the continuously usable (operable) time.

This transition occurs, for example, in a case where the user stops the operation of the user operation terminal 20 connected to the user non-operation terminal 30 and operates the user non-operation terminal 30 to continuously execute a direct operation of the user non-operation terminal 30, such as execution of a phone call, a mail, or another app, and the use (operation) time exceeds the continuously usable (operable) time.

In this case, as described above, the warning screen described above with reference to FIG. 15, namely
(c) the warning screen including a message indicating operation prohibition,
or the warning screen described with reference to FIG. 16, namely
(d) the warning screen in which a message, “Operation via connected terminal is possible”, is further added to the message indicating operation prohibition,
that is, one of these warning screens (c) and (d), is displayed on the display unit of the user non-operation terminal 30.
   (Transition from State 2c to State 2a)

The transition from state 2c to state 2a occurs in a case where, in state 2c, the user finishes using (operating) the user non-operation terminal 30 and, at a time of the finishing, the temperature of the terminal (user non-operation terminal 30) is within the range of reference 2(43° C. to 48° C.).

(Transition from State 2c to State 1)

The transition from state 2c to state 1 occurs in a case where, in state 2c, the user finishes using (operating) the user non-operation terminal 30) and, at a time of the finishing, the temperature of the terminal (user non-operation terminal 30) is within the range of reference 1(43° C. or lower).

(Transition from State 2c to State 3)

The transition from state 2c to state 1 occurs in a case where, in state 2c, the temperature of the terminal (user non-operation terminal 30) falls within the range of reference 3 (48° C. to 58° C.).

### 6. Warning Output Executed by User Non-Operation Terminal and Sequence of Process for Controlling Function Restriction

Warning output executed by the user non-operation terminal and a sequence of a process for controlling function restriction will be described.

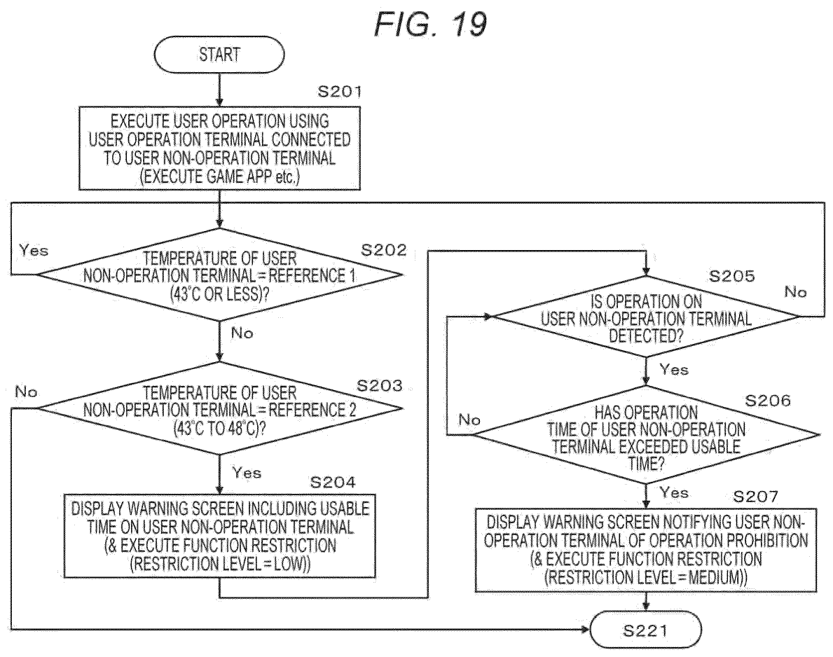

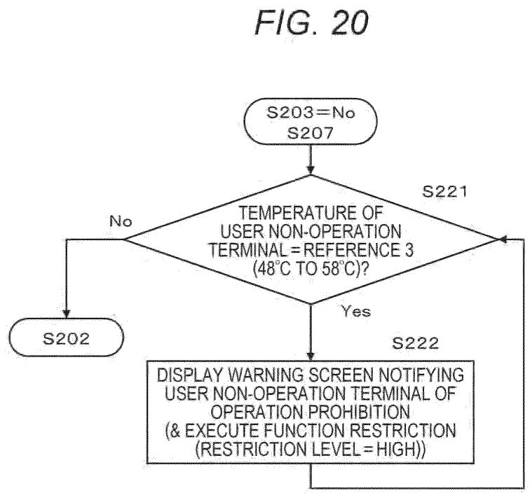

Flowcharts illustrated in FIGS. 19 and 20 are flowcharts illustrating the warning output executed by the control unit of the user non-operation terminal 30 and the sequence of the process for controlling function restriction.

Note that the process according to flows illustrated in FIGS. 19 and 20 is executed under the control of the control unit (data processing unit) of the user non-operation terminal 30 in accordance with a program stored in the storage unit of the user non-operation terminal 30, which is the information processing apparatus in the present disclosure. The control unit (data processing unit) includes a processor such as a CPU having a program execution function, for example, and can perform the processes according to the flow through processing for executing the program using the processor.

Processing in each of steps shown in the flowcharts of FIG. 19 and the subsequent drawing will be described.

### (Step S201)

First, in step S201, the user starts processing based on an app using the user operation terminal 20 connected to the user non-operation terminal 30. For example, a game app is used to start a game.

### (Step S202)

The control unit of the user non-operation terminal 30 obtains a value detected from the temperature sensor built in the user non-operation terminal 30, that is, the temperature of the user non-operation terminal 30, and determines whether or not the temperature of the user non-operation terminal 30 is the temperature of reference 1(43° C. or lower).

If the temperature of the user non-operation terminal 30 is the temperature of reference 1(43° C. or lower), the processing in step S202, that is, the processing for determining whether or not the temperature of the user non-operation terminal 30 is the temperature of reference 1(43° C. or lower), is repeatedly executed.

If it is determined that the temperature of the user non-operation terminal 30 is not the temperature of reference 1 (43° C. or lower), the process proceeds to step S203.

### (Step S203)

If it is determined in step S202 that the temperature of the user non-operation terminal 30 is not the temperature of reference 1(43° C. or lower), the process proceeds to step S203.

In this case, in step S203, the control unit of the user non-operation terminal 30 determines whether or not the temperature of the user non-operation terminal 30 is the temperature of reference 2(43° C. to 48° C.).

If the temperature of the user non-operation terminal 30 is the temperature of reference 2(43° C. to 48° C.), the process proceeds to step S204.

If the temperature of the user non-operation terminal 30 is not the temperature of reference 2(43° C. to 48° C.), on the other hand, the process proceeds to step S221.

### (Step S204)

If it is determined in step S203 that the temperature of the user non-operation terminal 30 is the temperature of reference 2(43° C. to 48° C.), the process proceeds to step S204.

In this case, in Step S204, the control unit of the user non-operation terminal 30 displays a warning screen including the usable (operable) time on the display unit of the user non-operation terminal 30.

That is, one of the warning screens described above with reference to FIGS. 13 and 14 is displayed.

Note that the processing for displaying a warning screen may be executed with touch processing on the display unit of the user non-operation terminal 30 by the user as a trigger, or may be executed with detection that the temperature of the user non-operation terminal 30 has become the temperature of reference 2 (43° C. to 48° C.) as a trigger.

Furthermore, in step S204, the control unit of the user non-operation terminal 30 also performs the function restriction of the user non-operation terminal 30. For example, function restriction processing such as decreasing the processing speed of the CPU is executed. A restriction level of the function restriction executed here, however, is low.

### (Step S205)

Next, in step S205, the control unit of the user non-operation terminal 30 determines whether or not a direct operation by the user on the user non-operation terminal 30 is detected.

If a direct operation by the user on the user non-operation terminal 30 is detected, the process proceeds to step S206.

If a direct operation by the user on the user non-operation terminal 30 is not detected, on the other hand, the process returns to step S202, and the processing in step S202 and subsequent steps is repeated.

### (Step S206)

If a direct operation by the user on the user non-operation terminal 30 is detected in step S205, the process proceeds to step S206.

In this case, in step S206, the control unit of the user non-operation terminal 30 determines whether or not the user's operation time on the user non-operation terminal 30 has exceeded the usable (operable) time.

Note that the usable (operable) time is the time displayed on the display unit in step S204 described above, and is the time displayed on one of the warning screens described above with reference to FIGS. 13 and 14.

If it is determined in step S206 that the user's operation time on the user non-operation terminal 30 has exceeded the usable (operable) time, the process proceeds to step S207.

If it is determined in step S206 that the user's operation time on the user non-operation terminal 30 has not exceeded the usable (operable) time, on the other hand, the process returns to step S205, and the determination processing in step S205 is repeated.

### (Step S207)

If it is determined in step S206 that the user's operation time on the user non-operation terminal 30 has exceeded the usable (operable) time, the process proceeds to step S207.

In this case, in step S207, the control unit of the user non-operation terminal 30 displays a warning screen including a message indicating an operation prohibition message on the display unit of the user non-operation terminal 30.

That is, one of the warning screens described above with reference to FIGS. 15 and 16 is displayed.

Note that the processing for displaying a warning screen may be executed with touch processing on the display unit of the user non-operation terminal 30 by the user as a trigger, or may be executed with detection that the user's operation time on the user non-operation terminal 30 has exceeded the usable (operable) time as a trigger.

Furthermore, in step S207, the control unit of the user non-operation terminal 30 also performs the function restriction of the user non-operation terminal 30. For example, function restriction processing such as decreasing the processing speed of the CPU is executed. The restriction level of the function restriction executed here, however, is medium, which is higher than the function restriction level achieved in step S204.

### (Step S221)

Processing in step S221 is performed if a result of the determination in step S203 is No or after the processing in step S207 is executed.

The result of the determination in step S203 is No if the temperature of the user non-operation terminal 30 is not the temperature of reference 2(43° C. to 48° C.), but the temperature of the user non-operation terminal 30 has been determined not to be the temperature of reference 1(43° C. or lower) in step S202 before the determination processing in step S203.

The result of the determination in step S203 is No, therefore, in a state in which the temperature of the user non-operation terminal 30 is estimated to be the temperature of reference 3(48° C. to 58° C.).

A time after the processing in step S207 is executed is after it is determined in step S206 that the user's operation time on the user non-operation terminal 30 has exceeded the usable (operable) time, and the processing for displaying a warning screen including an operation prohibition message is executed on the display unit of the user non-operation terminal 30.

In one of these cases, in step S221, the control unit of the user non-operation terminal 30 determines whether or not the temperature of the user non-operation terminal 30 is the temperature of reference 3(48° C. to 58° C.).

If the temperature of the user non-operation terminal 30 is the temperature of reference 3(48° C. to 58° C.), the process proceeds to step S222.

If the temperature of the user non-operation terminal 30 is not the temperature of reference 3(48° C. to 58° C.), on the other hand, the process returns to step S202, and the processing in step S202 and subsequent steps is repeated.

### (Step S222)

If the temperature of the user non-operation terminal 30 is the temperature of reference 3(48° C. to 58° C.) in step S221, the process proceeds to step S222.

In this case, in step S222, the control unit of the user non-operation terminal 30 displays a warning screen including an operation prohibition message on the display unit of the user non-operation terminal 30.

That is, one of the warning screens described above with reference to FIG. 17 is displayed.

Note that the processing for displaying a warning screen may be executed with touch processing on the display unit of the user non-operation terminal 30 by the user as a trigger, or may be executed with detection that the temperature of the user non-operation terminal 30 has become the temperature of reference 3 (48° C. to 58° C.) as a trigger.

Furthermore, in step S222, the control unit of the user non-operation terminal 30 also performs the function restriction of the user non-operation terminal 30. For example, function restriction processing such as decreasing the processing speed of the CPU is executed. The restriction level of the function restriction executed here, however, is high, which is higher than the function restriction level achieved in step S207.

As described above, the control unit of the user non-operation terminal 30 detects the temperature of the user non-operation terminal 30 on the basis of a value detected by the temperature sensor, and determines whether the temperature of the user non-operation terminal 30 is in any of the following temperature ranges:
the temperature of reference 1(43° C. or lower);
the temperature of reference 2(43° C. to 48° C.); and
the temperature of reference 3(48° C. to 58° C.).

Furthermore, if the temperature is the temperature of reference 2(43° C. to 48° C.), the operation time of the user non-operation terminal 30 by the user is measured.

The control unit of the user non-operation terminal 30 thus obtains the temperature of the user non-operation terminal 30 and the user operation time, and displays one of various warning screens on the display unit of the user non-operation terminal 30 in accordance with the obtained results.

That is, one of the various warning screens described with reference to FIGS. 13 to 17 is displayed on the display unit of the user non-operation terminal 30.

By viewing this warning screen, the user can accurately learn a temperature state of the user non-operation terminal 30, and it is possible to prevent occurrence of a low-temperature burn or the like due to an erroneous operation.

### 7. Embodiment in Which Temperature State of User Non-Operation Terminal Is Displayed on Display Unit of User Operation Terminal

Next, an embodiment in which the temperature state of the user non-operation terminal 30 is displayed on the display unit of the user operation terminal 20 will be described.

As described above, in a case where the user operation terminal 20 and the user non-operation terminal 30 are connected to each other and the user 10 executes an app of a game or the like while holding the user operation terminal 20 in his/her hands, since the user non-operation terminal 30 executes data processing with a large processing load, such as the processing for generating a 3D image, the temperature of the user non-operation terminal 30 increases and, depending on the case, might reach a level where the user cannot touch the user non-operation terminal 30.

In such a case, the above-described embodiment is an embodiment in which one of the various warning screens described with reference to FIGS. 13 to 17 is displayed on the display unit of the user non-operation terminal 30 to notify the user of the temperature state of the user non-operation terminal 30, thereby preventing occurrence of a low-temperature burn or the like in a case where the user operates the user non-operation terminal 30.

In a case where the user operation terminal 20 and the user non-operation terminal 30 are connected to each other and the user 10 executes an app of a game or the like while holding the user operation terminal 20 in his/her hands, however, there is a case where the user is concentrating on the screen of the user operation terminal 20 and is not looking at the user non-operation terminal 30 at all.

In such a case, for example, in a case where the user non-operation terminal 30 receives an incoming call, there is a possibility that the user answers the call while putting the user non-operation terminal 30 to his/her ear without viewing the warning screen displayed on the display unit of the user non-operation terminal 30.

In such a case, the user presses the hot user non-operation terminal 30 against the ear, which might cause a burn.

An embodiment described hereinafter is an embodiment in which such a situation can be prevented.

Specifically, this is an embodiment in which an icon, a warning message, or the like indicating the temperature state of the user non-operation terminal 30 is displayed on the display unit of the user operation terminal 20 on which the user is concentrating.

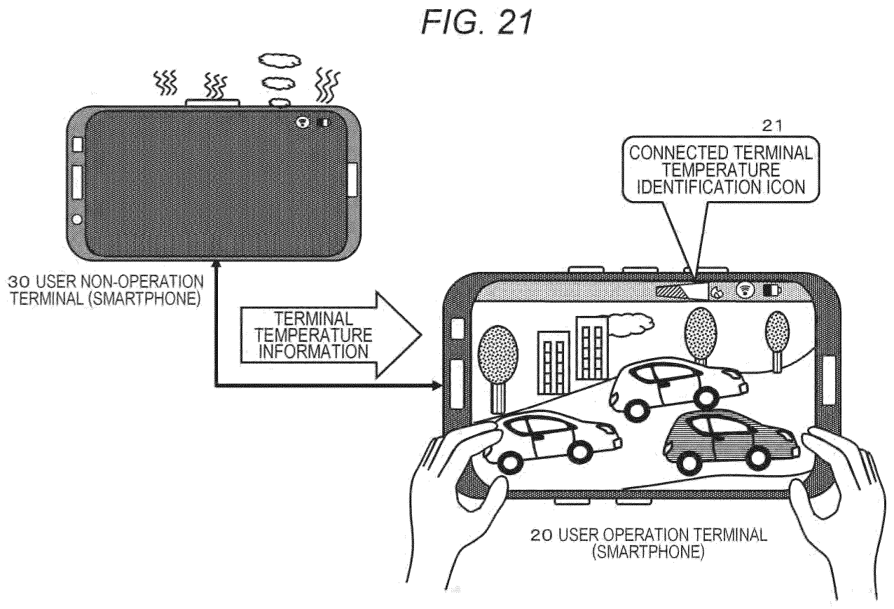

An outline of processing in the present embodiment will be described with reference to FIG. 21 and subsequent drawings.

FIG. 21 illustrates a state in which the user operation terminal 20 and the user non-operation terminal 30 are connected to each other, and the user executes a game app while holding the user operation terminal 20 in his/her hands.

The user non-operation terminal 30 executes data processing according to input information, such as user operation information, setting information, and sensor detection information, in the user operation terminal 20, that is, for example, the processing for generating a 3D image, the processing for generating sound information, and the vibration information, and transmits execution results (image, sound, and vibration information and the like) information to the user operation terminal 20 via the communication path.

Furthermore, the user non-operation terminal 30 also executes communication with the game server 50 via an external network such as the Internet, executes processing for generating output information regarding an image, a sound, and vibration according to operation information regarding other players and chat information, and transmits the generated image, sound, and vibration information and the like to the user operation terminal 20 via the communication path.

As described above, a processing load of the data processing executed by the user non-operation terminal 30 is large, and therefore the temperature of the terminal tends to be high.

The above-described embodiment is an embodiment in which one of the various warning screens described with reference to FIGS. 13 to 17 is displayed on the display unit of the user non-operation terminal 30, and when the user looks at the display unit of the user non-operation terminal 30 in order to operate the user non-operation terminal 30, the user can learn the temperature state of the user non-operation terminal 30 from the warning screen, thereby preventing occurrence of a low-temperature burn or the like in a case where the user operates the user non-operation terminal 30.

In contrast, the embodiment described hereinafter is an embodiment in which display data such as an icon, a warning message, or the like indicating the temperature state of the user non-operation terminal 30 is displayed on the display unit of the user operation terminal 20 on which the user is concentrating.

That is, this is an embodiment in which the user can learn the temperature state of the user non-operation terminal 30 without looking at the display unit of the user non-operation terminal 30.

Details of the present embodiment will be described with reference to FIG. 21 and subsequent drawings.

The user operation terminal 20 illustrated in FIG. 21 is a terminal whose display unit displays a game screen and that is held by the user who is executing the game in his/her hand in order to view the display unit.

As illustrated in FIG. 21, a “connected terminal temperature identification icon 21” that enables the user to check the temperature state of the connected terminal, that is, the user non-operation terminal 30, is displayed in an area (an upper area in the example illustrated in the drawing) of the display unit of the user operation terminal 20 on which the game screen is displayed.

Note that processing for displaying the “connected terminal temperature identification icon 21” can be executed, for example, in the following process sequence (S1 to S4).
(S1) The control unit of the user non-operation terminal 30 inputs the value detected by the temperature sensor and obtains the temperature (for example, 45° C.) of the user non-operation terminal 30.
(S2) The control unit of the user non-operation terminal 30 obtains an icon (image) corresponding to the obtained temperature (for example, 45° C.) from the storage unit in accordance with the obtained terminal temperature.
(S3) The control unit of the user non-operation terminal 30 transmits the icon (image) obtained from the storage unit to the user operation terminal 20 via the communication path.
(S4) The icon (image) received by the user operation terminal 20 is displayed on the display unit.

Note that the above sequence is a sequence for performing processing for selecting an icon (image) corresponding to the terminal temperature on the user non-operation terminal 30 side, but the selection of an icon (image) may be performed on the user operation terminal 20 side, instead.

For example, a sequence may be employed in which the value (for example, 45° C.) detected by the temperature sensor obtained by the control unit of the user non-operation terminal 30 is transmitted to the user operation terminal 20 as is and an icon (image) corresponding to the temperature is obtained from the storage unit of the user operation terminal 20 and displayed on the user operation terminal 20 side.

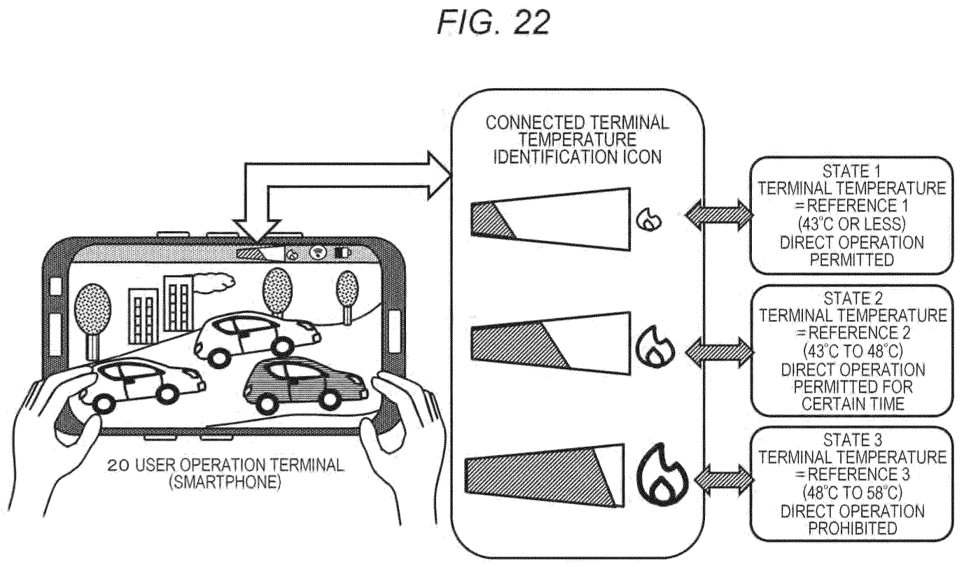

A specific example of the “connected terminal temperature identification icon 21” displayed on the display unit of the user operation terminal 20 will be described with reference to FIG. 22.

The example illustrated in FIG. 22 illustrates an example in which three types of icons according to the temperature of the user non-operation terminal 30 are set as “connected terminal temperature identification icons 21”, and one of these icons is selected and displayed in accordance with the terminal temperature.

In a case where the temperature of the user non-operation terminal 30 is the temperature of reference 1(43° C. or lower), an icon in which an internal indicator is moved to a left side is displayed as illustrated in the drawing.

In addition, in a case where the temperature of the user non-operation terminal 30 is the temperature of reference 2 (43° C. to 48° C.), an icon in which an internal indicator extends to a middle area is displayed as illustrated in the drawing.

Furthermore, in a case where the temperature of the user non-operation terminal 30 is the temperature of reference 3 (48° C. to 58° C.), an icon in which an internal indicator extends to a vicinity of a right end is displayed as illustrated in the drawing.

The user who is executing the game while viewing the game screen displayed on the display unit of the user operation terminal 20 can learn the temperature state of the user non-operation terminal 30 connected to the user operation terminal 20 by viewing one of these “connected terminal temperature identification icons 21” displayed in the upper area of the display unit.

Therefore, for example, even in a case where it is necessary to operate the user non-operation terminal 30, such as a case where there is an incoming call to the user non-operation terminal 30, it is possible to learn the temperature state of the user non-operation terminal 30 without touching the user non-operation terminal 30, and it is possible to prevent a burn in advance without touching the user non-operation terminal 30 that has become hot erroneously.

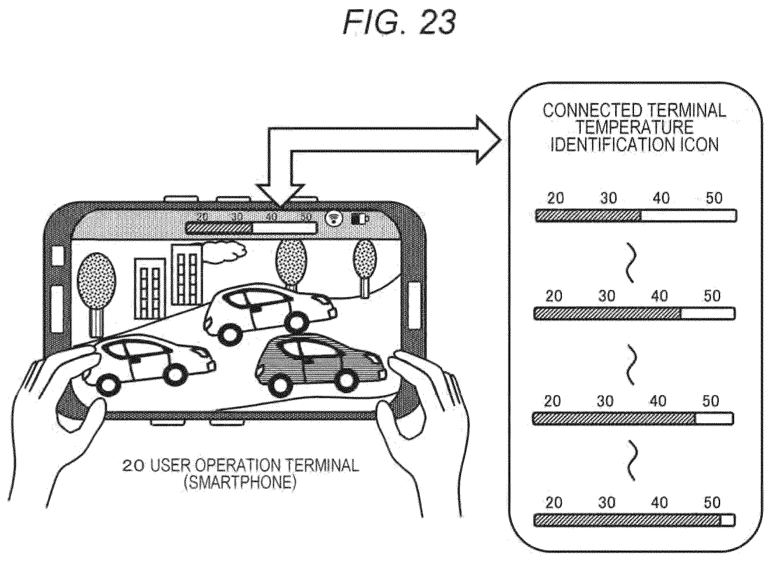

Note that the examples of the “connected terminal temperature identification icon 21” illustrated in FIG. 22 are examples, and other icons may be used, instead. For example, as illustrated in FIG. 23, the actual temperature of the user non-operation terminal 30 may be indicated using thermometer icons.

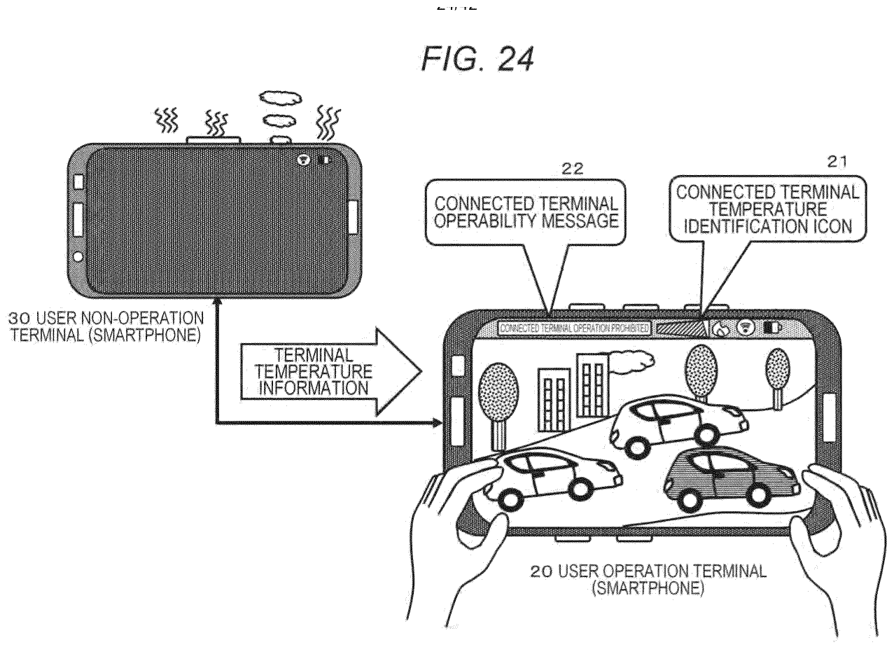

FIG. 24 illustrates an example in which a “connected terminal operability message 22” is further displayed on the display unit of the user operation terminal 20 in addition to the “connected terminal temperature identification icon 21”.

The “connected terminal operability message 22” shows different messages in accordance with the temperature state of the user non-operation terminal 30.

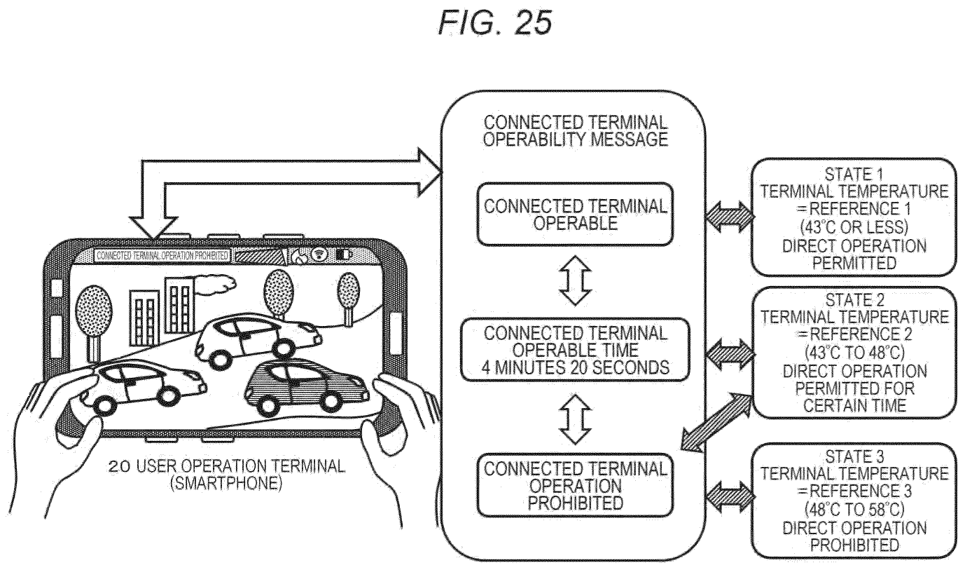

FIG. 25 illustrates a specific example.

As illustrated in FIG. 25,
in a case where the temperature of the user non-operation terminal 30 is the temperature of reference 1(43° C. or lower),
a message=“connected terminal operable” is displayed as the “connected terminal operability message 22” as illustrated in the drawing.

In addition, in a case where the temperature of the user non-operation terminal 30 is the temperature of reference 2 (43° C. to 48° C.),
a message=“connected terminal operable time: xx minutes yy seconds” is displayed as the “connected terminal operability message 22” as illustrated in the drawing.

Furthermore, in a case where the temperature of the user non-operation terminal 30 is the temperature of reference 3 (48° C. to 58° C.),
a message=“connected terminal operation prohibited” is displayed as the “connected terminal operability message 22” as illustrated in the drawing.

The user who is executing the game while viewing the game screen displayed on the display unit of the user operation terminal 20 can learn whether or not the user non-operation terminal 30 connected to the user operation terminal 20 is operable and operable time by viewing one of these “connected terminal operability messages 22” displayed in the upper area of the display unit.

Note that a display sequence of the “connected terminal operability message 22” can also be executed in, for example, the following sequence (S1 to S4), similarly to the display sequence of the “connected-terminal temperature identification icon 21” described above.
(S1) The control unit of the user non-operation terminal 30 inputs the value detected by the temperature sensor and obtains the temperature (for example, 45° C.) of the user non-operation terminal 30.
(S2) The control unit of the user non-operation terminal 30 obtains a message corresponding to the obtained temperature (for example, 45° C.) from the storage unit in accordance with the obtained terminal temperature.
(S3) The control unit of the user non-operation terminal 30 transmits the message obtained from the storage unit to the user operation terminal 20 via the communication path.
(S4) The message received by the user operation terminal 20 is displayed on the display unit.

Note that the above sequence is a sequence for performing processing for selecting a message corresponding to the terminal temperature on the user non-operation terminal 30 side, but the selection of a message may be performed on the user operation terminal 20 side, instead.

For example, a sequence may be employed in which the value (for example, 45° C.) detected by the temperature sensor obtained by the control unit of the user non-operation terminal 30 is transmitted to the user operation terminal 20 as is and a message corresponding to the temperature is obtained from the storage unit of the user operation terminal 20 and displayed on the user operation terminal 20 side.

### 8. Sequence of Process for Displaying Temperature State of User Non-Operation Terminal on Display Unit of User Operation Termina

Next, a sequence of a process for displaying the temperature state of the user non-operation terminal on the display unit of the user operation terminal will be described.

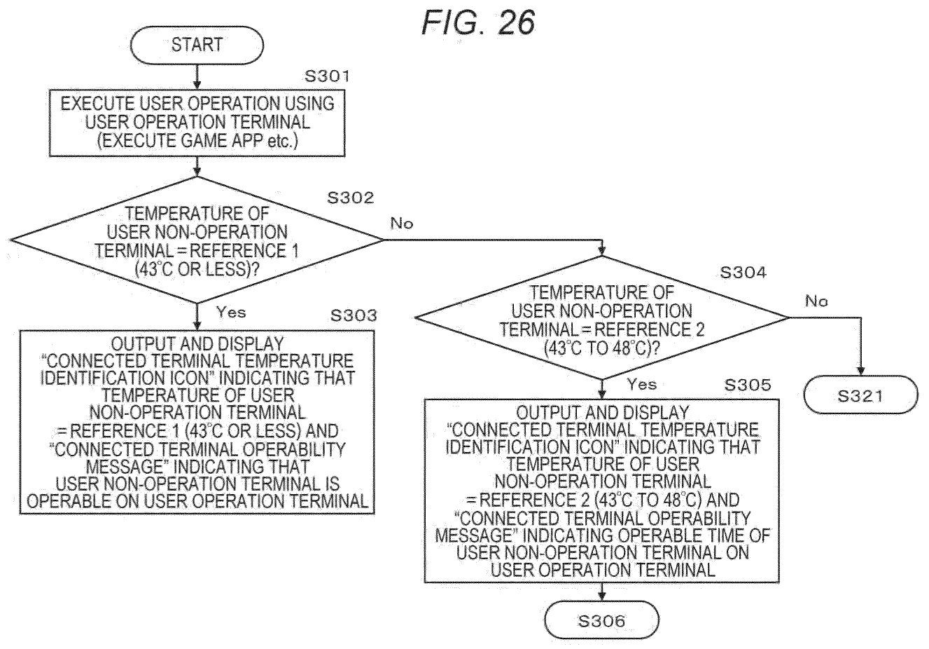

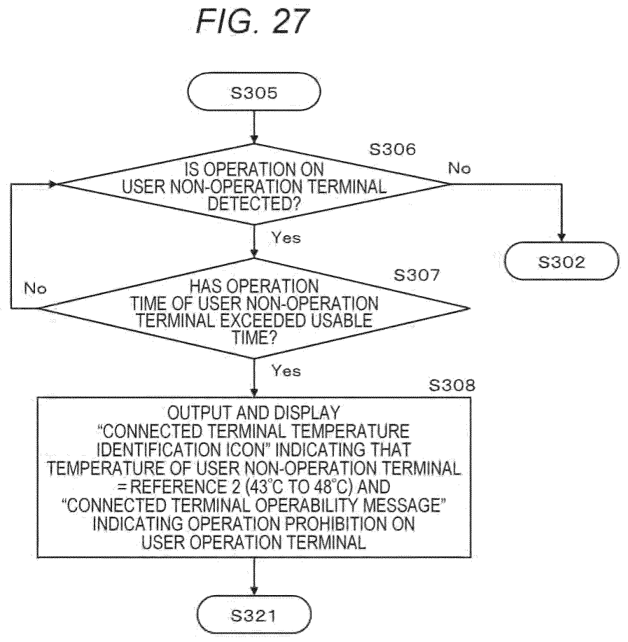

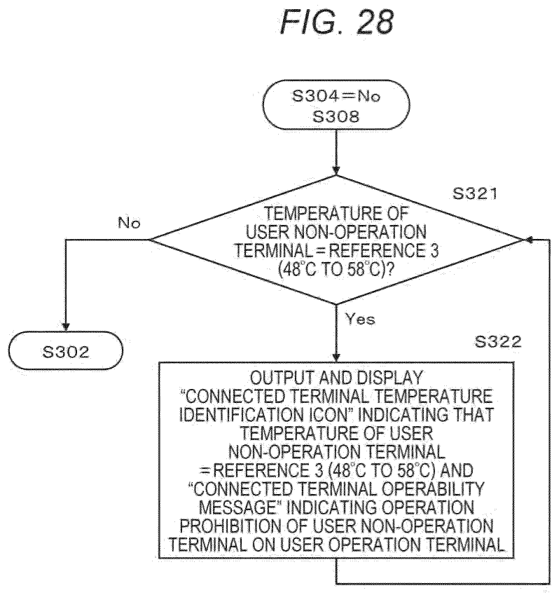

A sequence of the process described with reference to FIGS. 21 to 25, that is, the process for displaying an icon or a message indicating the temperature state of the user non-operation terminal 30 on the display unit of the user operation terminal 20, will be described with reference to flowcharts illustrated in FIGS. 26 to 28.

Note that the process according to flows illustrated in FIGS. 26 to 28 is executed under the control of the control unit (data processing unit) of each terminal in accordance with a program stored in the storage unit of the user operation terminal 20, which is the information processing apparatus in the present disclosure, or the user non-operation terminal 30. The control unit (data processing unit) includes a processor such as a CPU having a program execution function, for example, and can perform the processes according to the flow through processing for executing the program using the processor.

Processing in each of steps shown in the flowcharts of FIG. 26 and the subsequent drawings will be described.

### (Step S301)

First, in step S301, the user starts processing based on an app using the user operation terminal 20 connected to the user non-operation terminal 30. For example, a game app is used to start a game.

### (Step S302)

The control unit of the user non-operation terminal 30 obtains a value detected from the temperature sensor built in the user non-operation terminal 30, that is, the temperature of the user non-operation terminal 30, and determines whether or not the temperature of the user non-operation terminal 30 is the temperature of reference 1(43° C. or lower).

If the temperature of the user non-operation terminal 30 is the temperature of reference 1(43° C. or lower), the process proceeds to step S303.

If it is determined that the temperature of the user non-operation terminal 30 is not the temperature of reference 1 (43° C. or lower), on the other hand, the process proceeds to step S304.

### (Step S303)

If it is determined in step S302 that the temperature of the user non-operation terminal 30 is the temperature of reference 1(43° C. or lower), the process proceeds to step S303.

In this case, in step S303, the “connected terminal temperature identification icon” indicating that the temperature of the user non-operation terminal is reference 1(43° C. or lower) is displayed on the display unit of the user operation terminal 20. Furthermore, the “connected terminal operability message” indicating that the user non-operation terminal 30 is in an operable state is displayed. The icon and the message are the icon and the message described above with reference to FIGS. 21 to 25.

Note that a detailed sequence of processing for displaying the icon and the message in step S303 is, for example, the following sequence.
(S1) The control unit of the user non-operation terminal 30 inputs the value detected by the temperature sensor and obtains the temperature (for example, 45° C.) of the user non-operation terminal 30.
(S2) The control unit of the user non-operation terminal 30 obtains the icon and the message corresponding to the obtained temperature (for example, 45° C.) from the storage unit in accordance with the obtained terminal temperature.
(S3) The control unit of the user non-operation terminal 30 transmits the icon and the message obtained from the storage unit to the user operation terminal 20 via the communication path.
(S4) The icon and the message received by the user operation terminal 20 are displayed on the display unit.

Note that the above sequence is a sequence for performing the processing for selecting an icon and a message corresponding to the terminal temperature on the user non-operation terminal 30 side, but the selection of a message may be performed on the user operation terminal 20 side, instead.

For example, a sequence may be employed in which the value (for example, 45° C.) detected by the temperature sensor obtained by the control unit of the user non-operation terminal 30 is transmitted to the user operation terminal 20 as is and the icon and the message corresponding to the temperature are obtained from the storage unit of the user operation terminal 20 and displayed on the user operation terminal 20 side.

The processing for displaying the icon and the message is thus executed as joint processing between the control units of the user non-operation terminal 30 and the user operation terminal 20.

### (Step S304)

If it is determined in step S302 that the temperature of the user non-operation terminal 30 is not the temperature of reference 1 (43° C. or lower), the process proceeds to step S304.

In this case, in step S304, the control unit of the user non-operation terminal 30 determines whether or not the temperature of the user non-operation terminal 30 is the temperature of reference 2 (43° C. to 48° C.).

If the temperature of the user non-operation terminal 30 is the temperature of reference 2 (43° C. to 48° C.), the process proceeds to step S305.

If it is determined that the temperature of the user non-operation terminal 30 is not the temperature of reference 2 (43° C. to 48° C.), on the other hand, the process proceeds to step S321.

### (Step S305)

If it is determined in step S304 that the temperature of the user non-operation terminal 30 is the temperature of reference 2(43° C. to 48° C.), the process proceeds to step S305.

In this case, in step S305, the “connected terminal temperature identification icon” indicating that the temperature of the user non-operation terminal is the temperature of reference 2(43° C. to 48° C.) is displayed on the display unit of the user operation terminal 20. Furthermore, the “connected terminal operability message” indicating that the user non-operation terminal 30 is in the operable time state is displayed. The icon and the message are the icon and the message described above with reference to FIGS. 21 to 25.

Note that the processing for displaying the icon and the message is thus executed as joint processing between the control units of the user non-operation terminal 30 and the user operation terminal 20.

### (Step S306)

Next, in step S306, the control unit of the user non-operation terminal 30 determines whether or not a direct operation by the user on the user non-operation terminal 30 is detected.

If a direct operation by the user on the user non-operation terminal 30 is detected, the process proceeds to step S307.

If a direct operation by the user on the user non-operation terminal 30 is not detected, on the other hand, the process returns to step S302, and the processing in step S302 and subsequent steps is repeated.

### (Step S307)

If a direct operation by the user on the user non-operation terminal 30 is detected in step S306, the process proceeds to step S307.

In this case, in step S307, the control unit of the user non-operation terminal 30 determines whether or not the user's operation time on the user non-operation terminal 30 has exceeded the usable (operable) time.

Note that the usable (operable) time is the time displayed on the display unit of the user operation terminal 20 in step S305 described above, and is the time displayed on one of the messages described above with reference to FIG. 25.

If it is determined in step S307 that the user's operation time on the user non-operation terminal 30 has exceeded the usable (operable) time, the process proceeds to step S308.

If it is determined in step S307 that the user's operation time on the user non-operation terminal 30 has not exceeded the usable (operable) time, on the other hand, the process returns to step S306, and the determination processing in step S306 is repeated.

### (Step S308)

If it is determined in step S307 that the user's operation time on the user non-operation terminal 30 has exceeded the usable (operable) time, the process proceeds to step S308.

In this case, in step S308, the “connected terminal temperature identification icon” indicating that the temperature of the user non-operation terminal is the temperature of reference 2 (43° C. to 48° C.) is displayed on the display unit of the user operation terminal 20. Furthermore, the “connected terminal operability message” indicating that the user non-operation terminal 30 is in an inoperable state is displayed. The icon and the message are the icon and the message described above with reference to FIGS. 21 to 25.

Note that the processing for displaying the icon and the message is thus executed as joint processing between the control units of the user non-operation terminal 30 and the user operation terminal 20.

### (Step S321)

Processing in step S321 is performed if a result of the determination in step S304 is No or after the processing in step S308 is executed.

The result of the determination in step S304 is No if the temperature of the user non-operation terminal 30 is not the temperature of reference 2 (43° C. to 48° C.), but the temperature of the user non-operation terminal 30 has been determined not to be the temperature of reference 1 (43° C. or lower) in step S302 before the determination processing in step S304.

The result of the determination in step S304 is No, therefore, in a state in which the temperature of the user non-operation terminal 30 is estimated to be the temperature of reference 3 (48° C. to 58° C.).

A time after the processing in step S308 is executed is after it is determined in step S307 that the user's operation time on the user non-operation terminal 30 has exceeded the usable (operable) time, and the processing for displaying an operation prohibition message is executed on the display unit of the user operation terminal 20.

In one of these cases, in step S321, the control unit of the user non-operation terminal 30 determines whether or not the temperature of the user non-operation terminal 30 is the temperature of reference 3 (48° C. to 58° C.).

If the temperature of the user non-operation terminal 30 is the temperature of reference 3 (48° C. to 58° C.), the process proceeds to step S322.

If the temperature of the user non-operation terminal 30 is not the temperature of reference 3 (48° C. to 58° C.), on the other hand, the process returns to step S302, and the processing in step S302 and subsequent steps is repeated.

### (Step S322)

If the temperature of the user non-operation terminal 30 is the temperature of reference 3 (48° C. to 58° C.) in step S321, the process proceeds to step S322.

In this case, in step S322, the “connected terminal temperature identification icon” indicating that the temperature of the user non-operation terminal is the temperature of reference 3 (48° C. to 58° C.) is displayed on the display unit of the user operation terminal 20. Furthermore, the “connected terminal operability message” indicating that the user non-operation terminal 30 is in an inoperable state is displayed. The icon and the message are the icon and the message described above with reference to FIGS. 21 to 25.

Note that the processing for displaying the icon and the message is thus executed as joint processing between the control units of the user non-operation terminal 30 and the user operation terminal 20.

The sequence of the process described with reference to FIGS. 21 to 25, that is, the process for displaying an icon or a message indicating the temperature state of the user non-operation terminal 30 on the display unit of the user operation terminal 20, has been described.

As can be understood from these descriptions, the user can check the temperature and the operability of the user non-operation terminal 30 by viewing an icon or a message displayed on the display unit of the user operation terminal 20, which is displaying a game screen on which the user is concentrating.

As a result, it is possible to prevent a situation in which the user touches the user non-operation terminal 20 that has become hot, and it is possible to prevent occurrence of an accident such as a burn.

### 9. Embodiment in Which Warning Notification Is Performed When User Operation Terminal and User Non-Operation Terminal Are Disconnected from Each Other

Next, an embodiment in which warning notification is performed when the user operation terminal 20 and the user non-operation terminal 30 are disconnected from each other will be described.

It is assumed that, after the user operation terminal 20 and the user non-operation terminal 30 are connected to each other and the user 10 enjoys an app of a game or the like while holding the user operation terminal 20 in his/her hands, the user 10 disconnects the wired or wireless connection between the two terminals and starts to directly operate the user non-operation terminal 30.

In a case where the user non-operation terminal 30 is hot at this timing, there is a possibility that the user 10 gets burned.

In the embodiment described hereinafter is an embodiment in which such a situation is prevented from occurring.

Specifically, an icon indicating the temperature state of the user non-operation terminal 30 or a warning screen including a warning message and the like is displayed on the display unit of the user operation terminal 20 or the user non-operation terminal 30 at a timing when the user disconnects the user operation terminal 20 and the user non-operation terminal 30 from each other, or at a timing when the user starts disconnection processing using, for example, a disconnection processing UI or the like.

Note that the processing for disconnecting disconnection the user operation terminal 20 and the user non-operation terminal 30 from each other is performed as a process in which the user unplugs the connection cable between the terminals in the case of wired connection, and as processing for invalidating wireless connection in the case of wireless connection.

In addition, it is also assumed that the UI for disconnection is displayed on the user operation terminal 20 and the disconnection processing is performed using the UI.

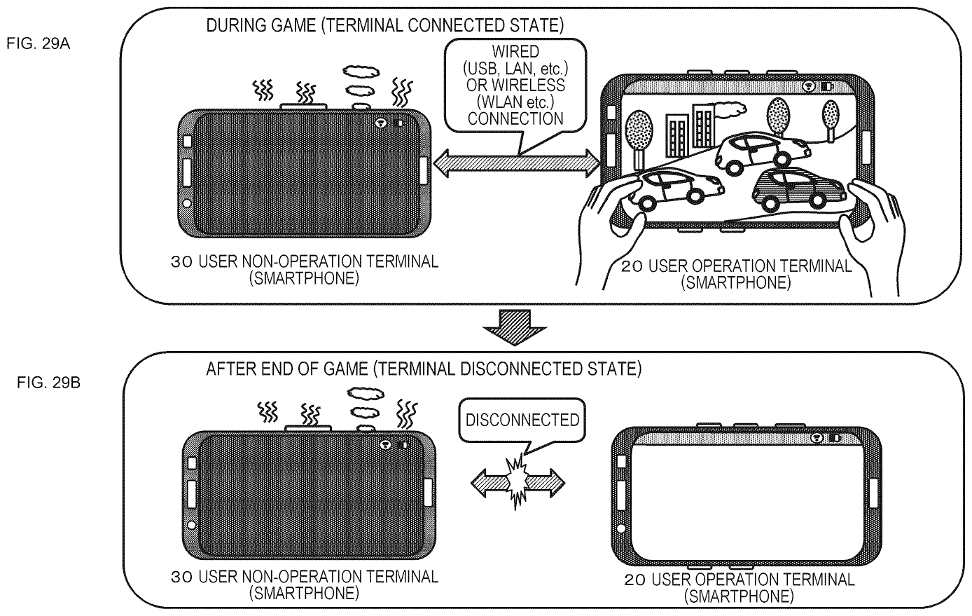

FIG. 29 is a diagram illustrating an example of disconnection of the user operation terminal 20 and the user non-operation terminal 30 from each other. FIG. 29 illustrates the following two diagrams.
(a) During game (terminal connected state)
(b) After end of game (terminal disconnected state)

“(a) During game (terminal connected state) is a state in which the user operation terminal 20 and the user non-operation terminal 30 are connected to each other, and the user executes an app of a game or the like while holding the user operation terminal 20 in his/her hands.

“(b) After end of game (terminal disconnected state)” indicates a state in which the user has terminated an app of a game or the like and has disconnected two terminals from each other.

In a case where the user non-operation terminal 30 is hot at a timing after the terminal disconnection, there is a possibility that the user gets burned when the user touches the user non-operation terminal 30.

In order to prevent occurrence of such a situation, in the present embodiment, when the user finishes an app of a game or the like and disconnects the two terminals from each other or starts the disconnection processing using the UI or the like, an icon indicating the temperature state of the user non-operation terminal 30 or a warning screen including a warning message and the like is displayed on the display unit of the user operation terminal 20 or the user non-operation terminal 30.

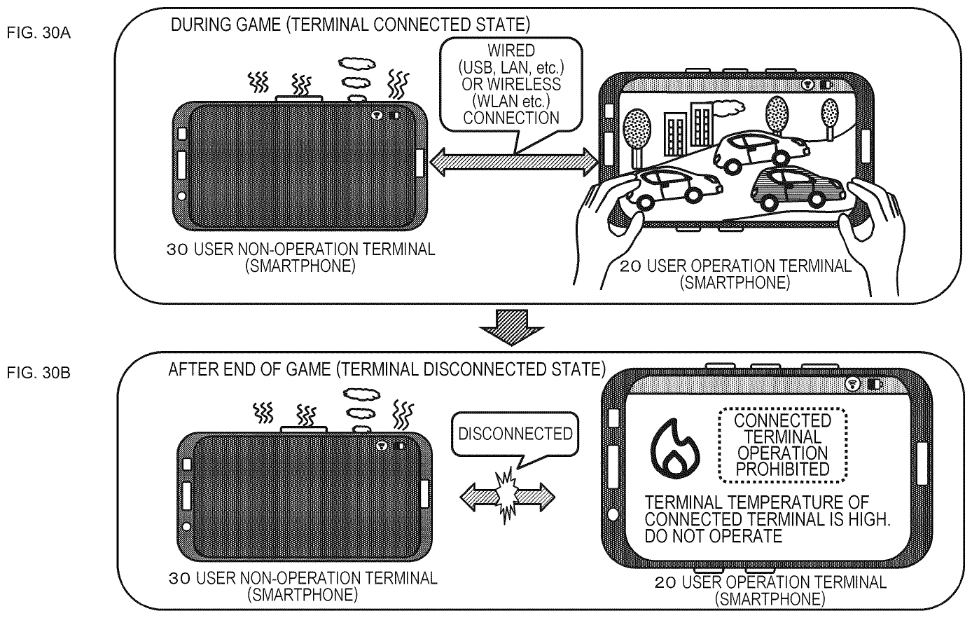

Examples of the processing for displaying a warning screen will be described with reference to FIG. 30 and subsequent drawings.

FIG. 30 illustrates an example of a warning screen displayed on the display unit of the user operation terminal 20 when the two terminals are disconnected from each other.

As illustrated in “(b) After end of game (terminal disconnected state)” in a lower part of FIG. 30, when the user terminates an app of a game or the like and disconnects the two terminals from each other, a warning screen illustrated in the drawing is displayed on the display unit of the user operation terminal 20.

That is, a warning message or the like indicating that the temperature of the connected terminal that has been disconnected is high and the connected terminal is in the operation prohibited state is displayed.

A warning screen of the user operation terminal 20 in FIG. 30(b) is displayed at the timing when the user disconnects the user operation terminal 20 and the user non-operation terminal 30 from each other. Specifically, in the case of wired connection, the warning screen is displayed when the cable is removed from the terminal, and in the case of wireless connection, the warning screen is displayed when the wireless connection is invalidated.

The control unit of the user operation terminal 20 detects that the cable has been removed from the terminal in the case of wired connection, and detects that the processing for invalidating wireless connection has been performed in the case of wireless connection, and displays the warning screen on the display unit of the user operation terminal 20 at these detection timings.

Note that the user operation terminal 20 continuously inputs the terminal temperature of the user non-operation terminal 30 at the time of connection with the user non-operation terminal 30, and the control unit of the user operation terminal 20 generates and displays a warning screen corresponding to the temperature of the user non-operation terminal 30 immediately before the user non-operation terminal 30 is disconnected.

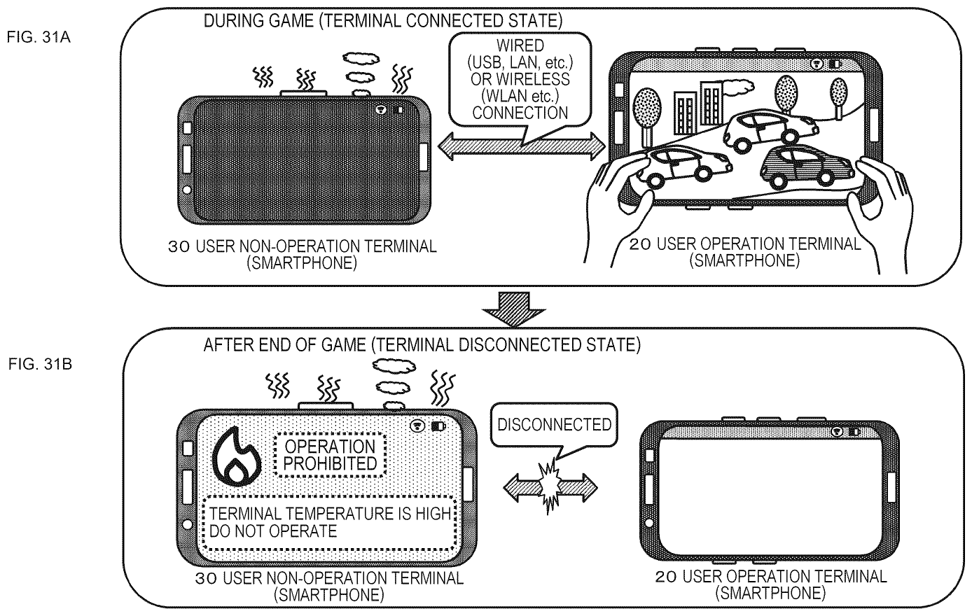

The example illustrated in FIG. 30 is an example in which the warning screen is displayed on the display unit of the user operation terminal 20, but as illustrated in FIG. 31(b), for example, the warning screen may be displayed on the display unit of the user non-operation terminal 30, instead.

In an example illustrated in FIG. 31, the control unit of the user non-operation terminal 30 detects that the cable has been removed from the terminal in the case of wired connection, and detects that the processing for invalidating wireless connection has been performed in the case of wireless connection.

The control unit of the user non-operation terminal 30 generates a warning screen corresponding to the temperature of the user non-operation terminal 30 at these detection timings, and displays the warning screen on the display unit of the user non-operation terminal 30.

Furthermore, the control units of the user operation terminal 20 and the user non-operation terminal 30 may display a warning screen on the display units in parallel.

Note that the warning screens illustrated in FIGS. 30 and 31 are examples of warning screens displayed in the case of (reference 3) described above with reference to FIG. 12, that is, displayed when the terminal temperature of the user non-operation terminal 30 is 48° C. to 58° C., and are warning screens for prohibiting the user operation of the user non-operation terminal 30.

In a case where the terminal temperature of the user non-operation terminal 30 is 48° C. to 58° C., a warning message for notifying of operation prohibition of the user non-operation terminal 30 is displayed as illustrated in FIGS. 30 and 31. Note that these warning screens are examples, and other messages may be displayed.

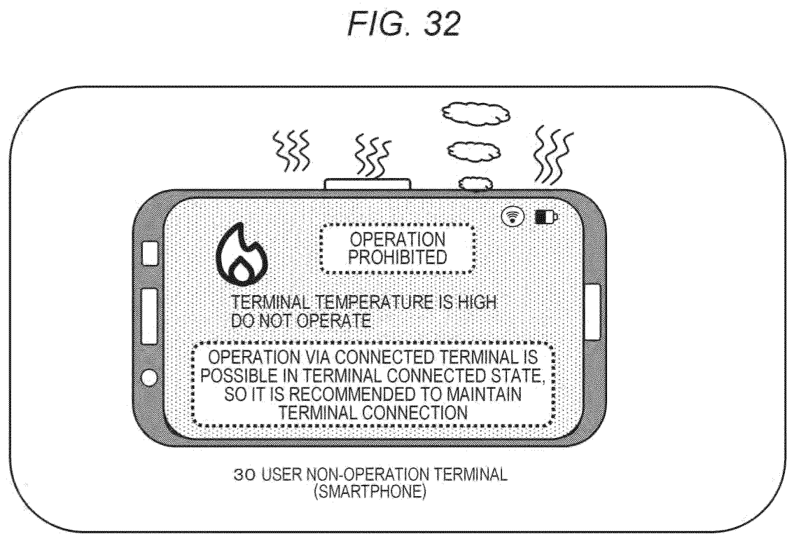

For example, as illustrated in FIG. 32, the following message may be displayed in addition to the warning message notifying of operation prohibition of the user non-operation terminal 30.

“Operation via connected terminal is possible in terminal connected state, so it is recommended to maintain terminal connection”

By viewing this display, the user can take a measure such as restoring the connection state between the user operation terminal 20 and the user non-operation terminal 30 and executing the operation of the user non-operation terminal 30 via the user operation terminal 20.

Specifically, for example, processing of a phone call, an email, or other apps for the user non-operation terminal 30 that might not be executable if the terminals are disconnected from each other immediately after the user enjoys the game can be executed via the user operation terminal 20.

Note that the example illustrated in FIG. 32 is an example in which a warning screen is displayed on the display unit of the user non-operation terminal 30, but a similar warning screen may be displayed on the display unit of the user operation terminal 20, instead.

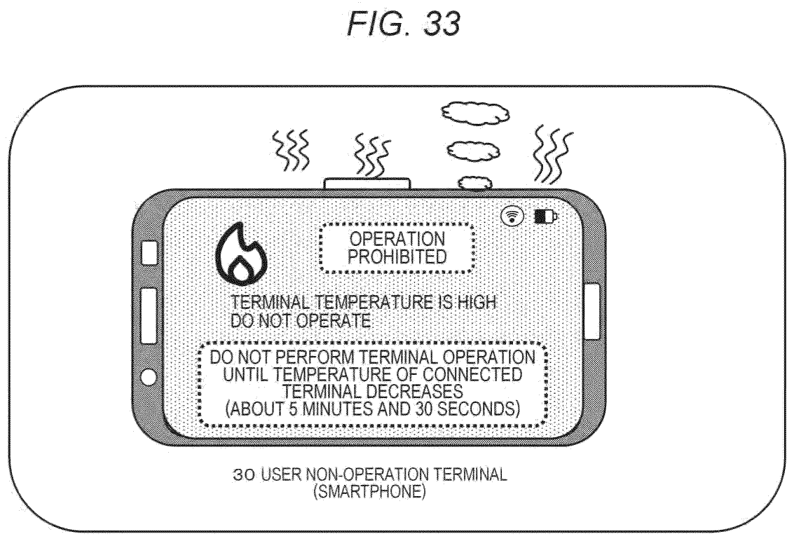

Furthermore, FIG. 33 illustrates another display example of the warning screen.

The warning screen illustrated in FIG. 33 is an example in which the following message is displayed in addition to the warning message notifying of operation prohibition of the user non-operation terminal 30.

“Do not perform terminal operation until temperature of connected terminal decreases (about 5 minutes and 30 seconds)”

This warning screen is an example in which time until a high-temperature state of the user non-operation terminal 30 is resolved and the user can safely perform operations is shown.

The user views this display, waits for the specified time (about 5 minutes and 30 seconds), and then operates the user non-operation terminal 30, thereby enabling safe operation without getting burned.

Note that the example illustrated in FIG. 33, too, is an example in which a warning screen is displayed on the display unit of the user non-operation terminal 30, but a similar warning screen may be displayed on the display unit of the user operation terminal 20, instead.

Note that the warning screens illustrated in FIGS. 32 and 33 are examples of warning screens displayed in the case of (reference 3) described above with reference to FIG. 12, that is, displayed when the terminal temperature of the user non-operation terminal 30 is 48° C. to 58° C., and are warning screens for prohibiting the user operation of the user non-operation terminal 30.

The warning screen in the case where the terminal temperature of the user non-operation terminal 30 is (reference 2) described above with reference to FIG. 12, that is, 43° C. to 48° C., is, as described above with reference to FIGS. 13 and 14, a warning screen indicating the usable (operable) time information or a warning screen including a combination of the usable (operable) time information and a message indicating that the function restriction is being executed.

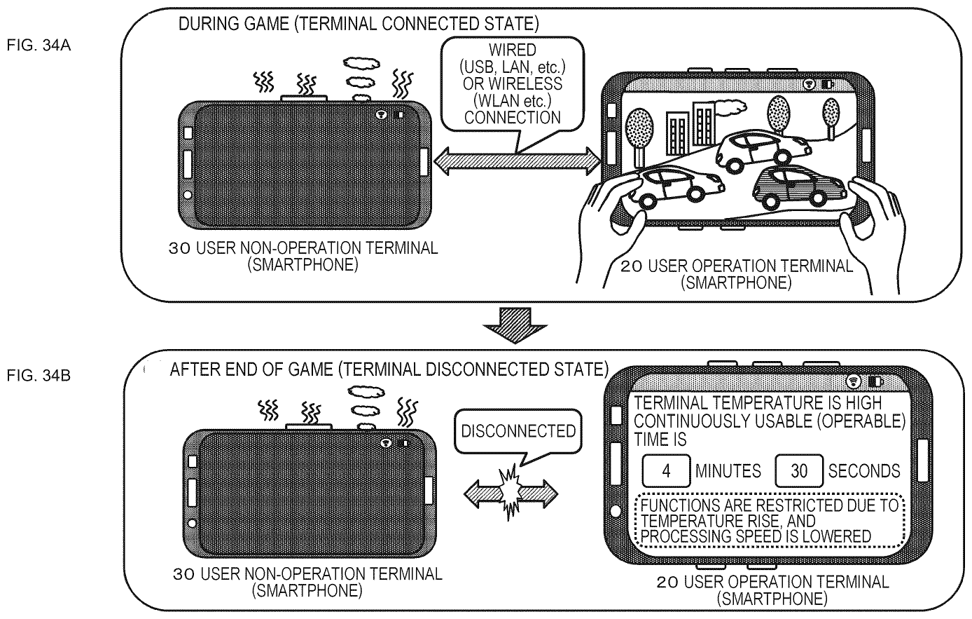

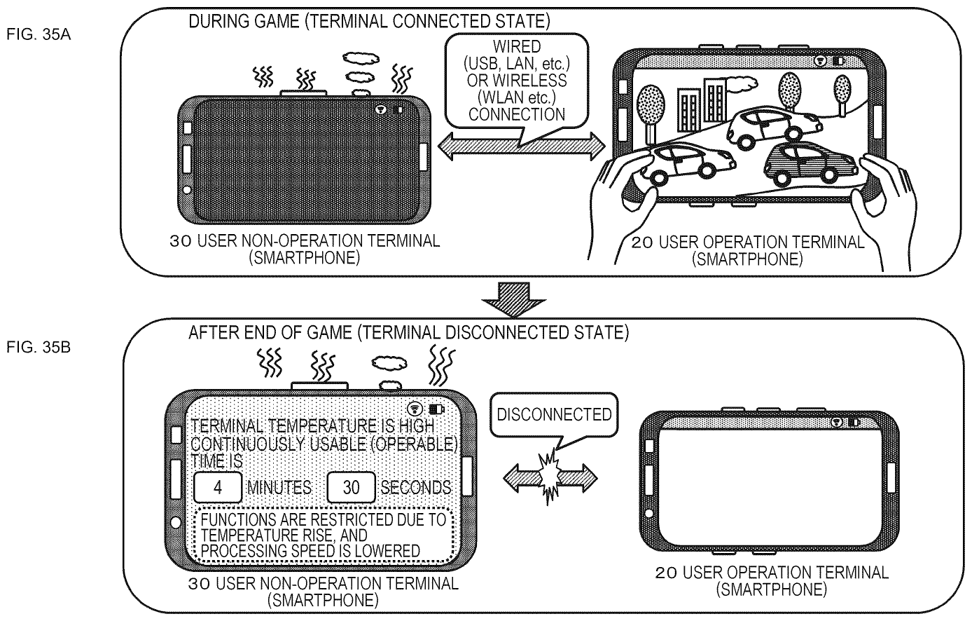

FIGS. 34 and 35 illustrate display examples of the warning screen in this case.

FIG. 34 illustrates an example of a warning screen displayed on the display unit of the user operation terminal 20 in a case where the two terminals are disconnected from each other and the terminal temperature of the user non-operation terminal 30 is (reference 2) described above with reference to FIG. 12, that is, the terminal temperature=43° C. to 48° C.

As illustrated in “(b) After end of game (terminal disconnected state)” in a lower part of FIG. 34, when the user terminates an app of a game or the like and disconnects the two terminals from each other, the warning screen illustrated in the drawing is displayed on the display unit of the user operation terminal 20.

That is, a warning screen including a combination of the usable (operable) time information and a message indicating that the function restriction is being executed is displayed on the display unit of the user operation terminal 20.

The control unit of the user operation terminal 20 detects a disconnection timing between the user operation terminal 20 and the user non-operation terminal 30, and the warning screen on the user operation terminal 20 in FIG. 34(b) is displayed on the display unit at the detection timing.

Note that the control unit of the user operation terminal 20 generates and displays the warning screen illustrated in FIG. 34(b) after confirming that the temperature of the user non-operation terminal 30 immediately before the user operation terminal 20 is disconnected from the user non-operation terminal 30 is (reference 2), that is, the terminal temperature=43° C. to 48° C.

The example illustrated in FIG. 34 is an example in which the warning screen is displayed on the display unit of the user operation terminal 20, but as illustrated in FIG. 35(b), for example, the warning screen may be displayed on the display unit of the user non-operation terminal 30, instead.

In the example illustrated in FIG. 35, the control unit of the user non-operation terminal 30 detects that the cable has been removed from the terminal in the case of wired connection, and detects that the processing for invalidating wireless connection has been performed in the case of wireless connection.

Furthermore, the control unit of the user non-operation terminal 30 confirms that the temperature of the user non-operation terminal 30 at these detection timings is (reference 2), that is, the terminal temperature=43° C. to 48° C.

The control unit of the user non-operation terminal 30 displays the warning screen illustrated in FIG. 35, that is, a warning screen including a combination of the usable (operable) time information and a message indicating that the function restriction is being executed, on the display unit of the user non-operation terminal 30.

Note that the control units of the user operation terminal 20 and the user non-operation terminal 30 may display a warning screen on the display units in parallel.

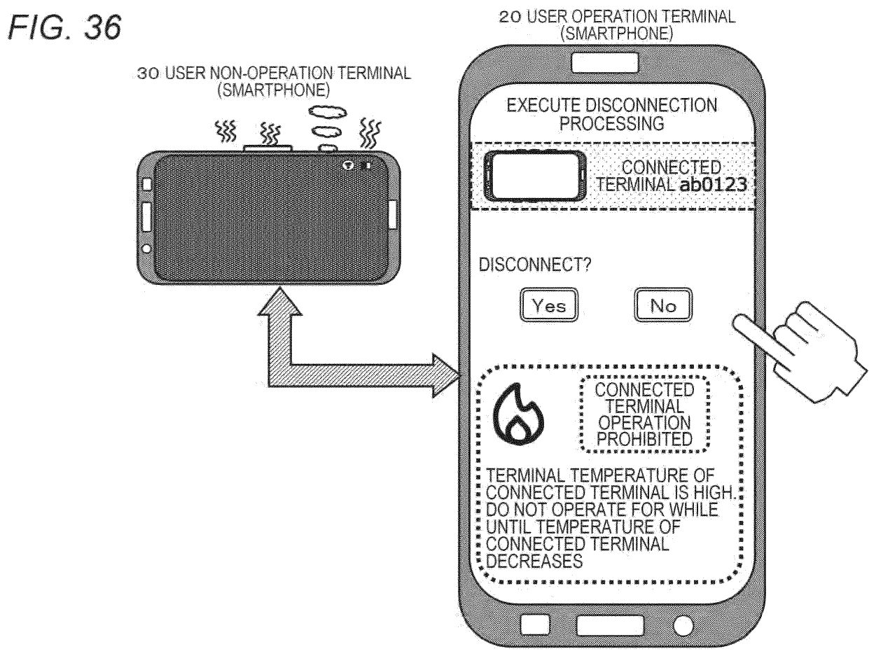

Next, an example of a warning screen displayed on the display unit of the user operation terminal 20 when the disconnection processing UI is displayed on the user operation terminal 20 and the disconnection processing is started in a state where the user operation terminal 20 and the user non-operation terminal 30 are connected to each other will be described with reference to FIG. 36 and subsequent drawings.

FIG. 36 illustrates the user operation terminal 20 and the user non-operation terminal 30. These two terminals are currently in a connected state.

The user displays the disconnection processing UI on the user operation terminal 20 to start the disconnection processing.

As illustrated in the drawing,
an inquiry, “Disconnect?”, is displayed on the display unit of the user operation terminal 20 as the disconnection processing UI, and
two selection buttons “Yes” and “No” are displayed.

If the user touches the “Yes” button, the connected state between the user operation terminal 20 and the user non-operation terminal 30 is canceled.

A warning screen illustrated in the drawing is displayed in a part of the disconnection processing UI.

That is, a warning screen or the like including a warning message notifying that the connected terminal is hot and in the operation prohibited state is displayed in a lower area of the display unit of the user operation terminal 20 illustrated in FIG. 36.

Note that the example illustrated in FIG. 36 is an example of a warning screen displayed in the case where the temperature of the user non-operation terminal 30 is (reference 3) described above with reference to FIG. 12, that is, displayed when the terminal temperature of the user non-operation terminal 30 is 48° C. to 58° C., and is a screen for notifying that the user non-operation terminal 30 is in the operation prohibited state.

The user can check this warning screen and learn in advance that the user non-operation terminal 30 to be disconnected cannot be operated due to high temperature.

Note that in a case where the terminal temperature of the user non-operation terminal 30 is (reference 2), that is, 43° C. to 48° C., a warning screen similar to that described above with reference to FIG. 34, that is, a warning screen including a combination of the usable (operable) time information and a message indicating that the function restriction is being executed, is displayed.

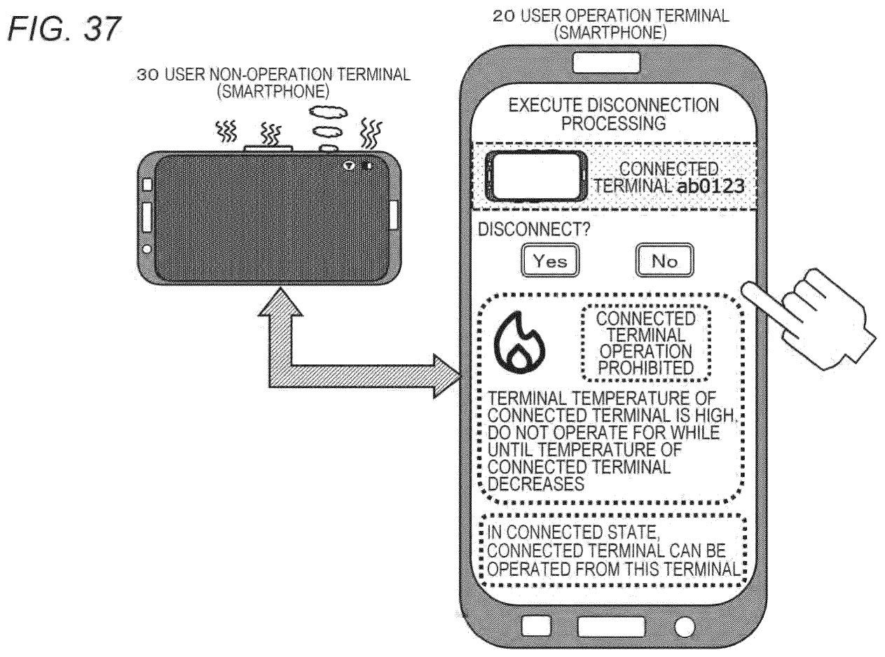

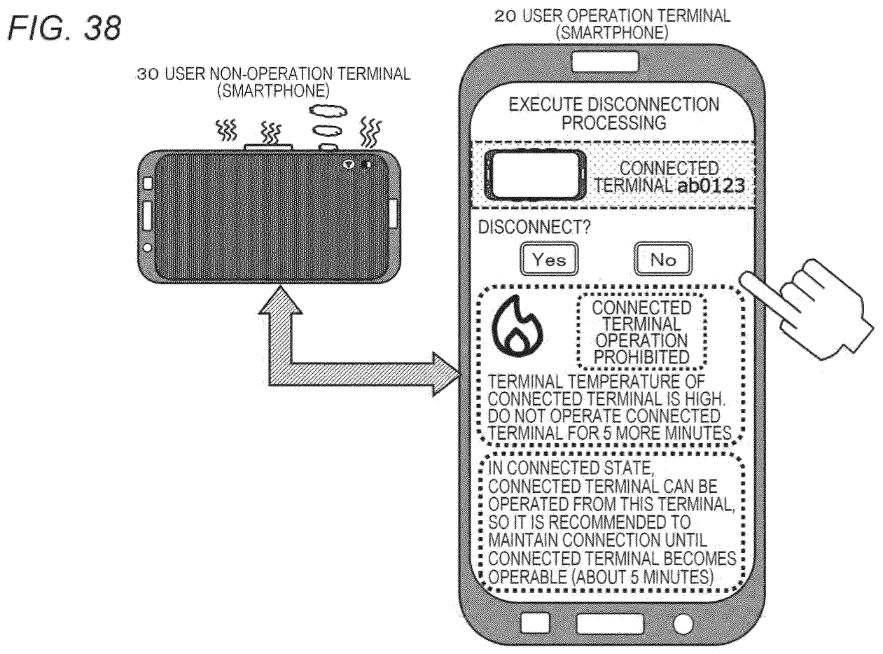

Other examples of the warning screen displayed together with the disconnection processing UI displayed on the user operation terminal 20 will be described with reference to FIGS. 37 and 38.

FIG. 37 illustrates an example in which the following message is further displayed on the disconnection processing UI displayed on the user operation terminal 20.

“In connected state, connected terminal can be operated from this terminal”

This message is a message notifying that the user non-operation terminal 30 can be operated from the user operation terminal 20 by maintaining the connection state between the user operation terminal 20 and the user non-operation terminal 30.

By viewing this display, the user can stop disconnecting the user operation terminal 20 and the user non-operation terminal 30 from each other and operate the user non-operation terminal 30 via the user operation terminal 20.

Furthermore, FIG. 38 illustrates another display example of the warning screen.

The warning screen illustrated in FIG. 38 is an example in which the following message is further displayed on the disconnection processing UI displayed on the user operation terminal 20.

“Terminal temperature of connected terminal is high. Do not operate connected terminal for 5 more minutes”

“In connected state, connected terminal can be operated from this terminal, so it is recommended to maintain connected state until connected terminal becomes operable (about 5 minutes)”

This warning screen is an example in which a message notifying of the time until the high-temperature state of the user non-operation terminal 30 is resolved and the user can safely operate the user non-operation terminal 30 and notifying that the user non-operation terminal 30 can be operated from the user operation terminal 20 by maintaining the connected state between the user operation terminal 20 and the user non-operation terminal 30 is displayed.

The user sees this display, can wait for the specified time (about 5 minutes), and then operate the user non-operation terminal 30, or can maintain the connected state between the user operation terminal 20 and the user non-operation terminal 30 and operate the user non-operation terminal 30 from the user operation terminal 20.

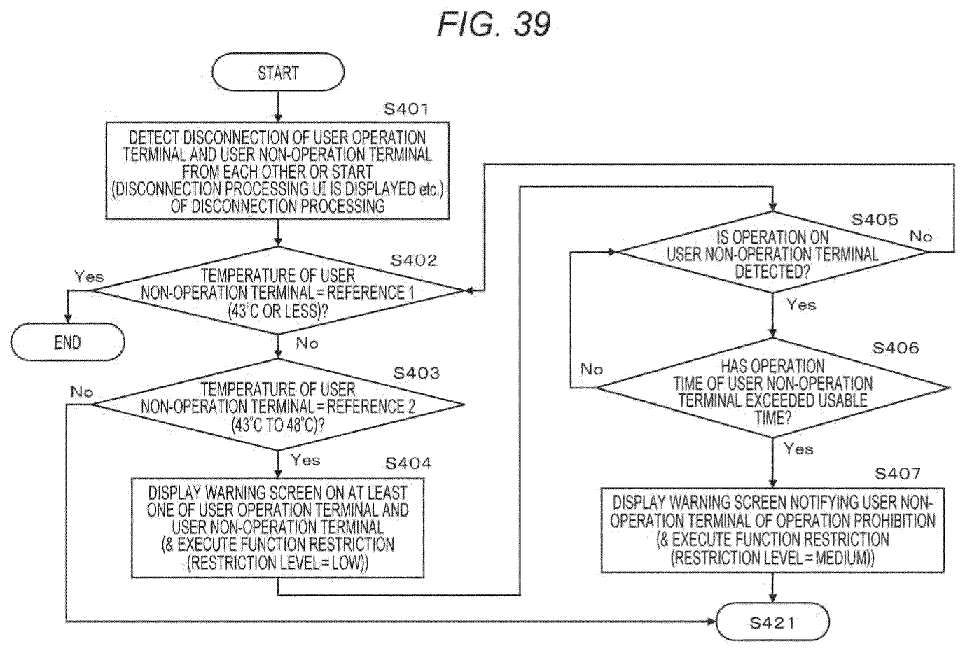

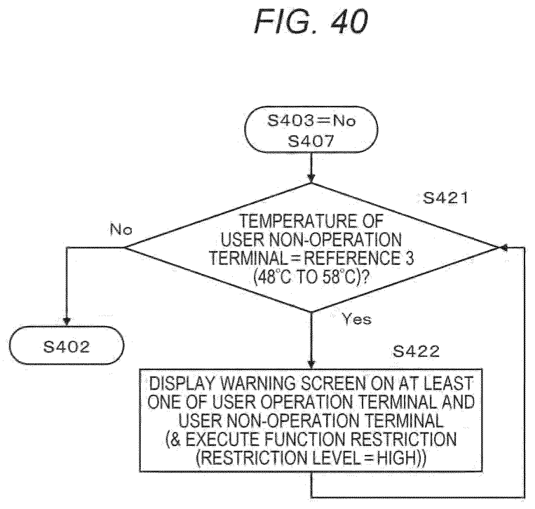

Next, a sequence of the warning output and the process for controlling function restriction according to the present embodiment will be described with reference to flowcharts illustrated in FIGS. 39 and 40.

Note that the process according to flows illustrated in FIGS. 39 and 40 is executed under the control of the control unit (data processing unit) of each terminal in accordance with a program stored in the storage unit of the user operation terminal 20, which is the information processing apparatus in the present disclosure, or the user non-operation terminal 30. The control unit (data processing unit) includes a processor such as a CPU having a program execution function, for example, and can perform the process according to the flows through processing for executing the program using the processor.

Processing in each of steps shown in the flowcharts of FIG. 39 and the subsequent drawing will be described.

### (Step S401)

First, in step S401, the control unit of the user operation terminal 20 or the user non-operation terminal 30 detects that the user executes the processing for disconnecting the user operation terminal 20 and the user non-operation terminal 30 from each other or detects a start of the processing.

The execution of the disconnection processing is, for example, processing for removing the connection cable in the case of wired connection and the process for invalidating connection or the like in the case of wireless connection. The start of the disconnection processing is, for example, processing for displaying the disconnection UI on the user operation terminal 20 or the like.

The control unit of the user operation terminal 20 or the user non-operation terminal 30 detects the processing.

### (Step S402)

Next, the control unit of the user operation terminal 20 or the user non-operation terminal 30 obtains the temperature of the user non-operation terminal 30 at a timing of step S401 (disconnection timing between the terminals or a disconnection processing start timing), and determines whether or not the temperature of the user non-operation terminal 30 is the temperature of reference 1 (43° C. or lower).

If the temperature of the user non-operation terminal 30 is the temperature of reference 1 (43° C. or lower), the process ends.

That is, the processing for displaying a warning screen or the like is not performed. In this case, the user non-operation terminal 30 is not in the high-temperature state, and the user can safely operate the user non-operation terminal 30.

If the control unit of the user operation terminal 20 or the user non-operation terminal 30 determines in step S402 that the temperature of the user non-operation terminal 30 is not the temperature of reference 1 (43° C. or lower), the process proceeds to step S403.

### (Step S403)

If determining in step S402 that the temperature of the user non-operation terminal 30 is not the temperature of reference 1(43° C. or lower), the control unit of the user operation terminal 20 or the user non-operation terminal 30 determines in step S403 whether or not the temperature of the user non-operation terminal 30 is the temperature of reference 2 (43° C. to 48° C.).

If the temperature of the user non-operation terminal 30 is the temperature of reference 2 (43° C. to 48° C.), the process proceeds to step S404.

If the temperature of the user non-operation terminal 30 is not the temperature of reference 2 (43° C. to 48° C.), on the other hand, the process proceeds to step S421.

### (Step S404)

If it is determined in step S403 that the temperature of the user non-operation terminal 30 is the temperature of reference 2 (43° C. to 48° C.), the process proceeds to step S404.

In this case, in step S404, a warning screen is displayed on the display unit of at least one of the user operation terminal 20 and the user non-operation terminal 30.

This warning screen is, for example, one of the warning screens described above with reference to FIGS. 34 to 35.

That is, a warning screen including a combination of the usable (operable) time information and a message indicating that the function restriction is being executed or the like is displayed.

Note that, as described with reference to FIGS. 36 and 37, in a case where the disconnection UI is displayed on the user operation terminal 20, a warning screen including a combination of the usable (operable) time information and a message indicating that the function restriction is being executed or the like is displayed together with the UI.

Furthermore, in step S404, the control unit of the user non-operation terminal 30 also performs the function restriction of the user non-operation terminal 30. For example, function restriction processing such as decreasing the processing speed of the CPU is executed. A restriction level of the function restriction executed here, however, is low.

### (Step S405)

Next, in step S405, the control unit of the user non-operation terminal 30 determines whether or not a direct operation by the user on the user non-operation terminal 30 is detected.

If a direct operation by the user on the user non-operation terminal 30 is detected, the process proceeds to step S406.

If a direct operation by the user on the user non-operation terminal 30 is not detected, on the other hand, the process returns to step S402, and the processing in step S402 and subsequent steps is repeated.

### (Step S406)

If a direct operation by the user on the user non-operation terminal 30 is detected in step S405, the process proceeds to step S406.

In this case, in step S406, the control unit of the user non-operation terminal 30 determines whether or not the user's operation time on the user non-operation terminal 30 has exceeded the usable (operable) time.

Note that the usable (operable) time is the time displayed on the display unit in step S404 described above, and is the time displayed on one of the warning screens described above with reference to FIGS. 34 and 35.

If it is determined in step S406 that the user's operation time on the user non-operation terminal 30 has exceeded the usable (operable) time, the process proceeds to step S407.

If it is determined in step S406 that the user's operation time on the user non-operation terminal 30 has not exceeded the usable (operable) time, on the other hand, the process returns to step S405, and the determination processing in step S405 is repeated.

### (Step S407)

If it is determined in step S406 that the user's operation time on the user non-operation terminal 30 has exceeded the usable (operable) time, the process proceeds to step S407.

In this case, in step S407, the control unit of the user non-operation terminal 30 displays a warning screen including an operation prohibition message on the display unit of the user non-operation terminal 30.

The warning screen in this case is one of the warning screens described above with reference to FIGS. 32 and 33.

Note that the processing for displaying a warning screen may be executed with touch processing on the display unit of the user non-operation terminal 30 by the user as a trigger, or may be executed with detection that the user's operation time on the user non-operation terminal 30 has exceeded the usable (operable) time as a trigger.

Furthermore, in step S407, the control unit of the user non-operation terminal 30 also performs the function restriction of the user non-operation terminal 30. For example, function restriction processing such as decreasing the processing speed of the CPU is executed. The restriction level of the function restriction executed here, however, is medium, which is higher than the function restriction level achieved in step S404.

### (Step S421)

Processing in step S421 is performed if a result of the determination in step S403 is No or after the processing in step S407 is executed.

The result of the determination in step S403 is No if the temperature of the user non-operation terminal 30 is not the temperature of reference 2 (43° C. to 48° C.), but the temperature of the user non-operation terminal 30 has been determined not to be the temperature of reference 1 (43° C. or lower) in step S402 before the determination processing in step S403.

The result of the determination in step S403 is No, therefore, in a state in which the temperature of the user non-operation terminal 30 is estimated to be the temperature of reference 3 (48° C. to 58° C.).

A time after the processing in step S407 is executed is after it is determined in step S406 that the user's operation time on the user non-operation terminal 30 has exceeded the usable (operable) time, and the processing for displaying a warning screen including an operation prohibition message is executed on the display unit of the user non-operation terminal 30.

In one of these cases, in step S421, the control unit of the user non-operation terminal 30 determines whether or not the temperature of the user non-operation terminal 30 is the temperature of reference 3 (48° C. to 58° C.).

If the temperature of the user non-operation terminal 30 is the temperature of reference 3 (48° C. to 58° C.), the process proceeds to step S422.

If the temperature of the user non-operation terminal 30 is not the temperature of reference 3 (48° C. to 58° C.), on the other hand, the process returns to step S402, and the processing in step S402 and subsequent steps is repeated.

(step S422)

If the temperature of the user non-operation terminal 30 is the temperature of reference 3 (48° C. to 58° C.) in step S421, the process proceeds to step S422.

In this case, in step S422, the control unit of the user operation terminal 20 or the user non-operation terminal 30 displays a warning screen including an operation prohibition message on the display unit of the user operation terminal 20 or the user non-operation terminal 30.

That is, one of the warning screens described above with reference to FIGS. 30 to 33 is displayed.

Note that, as described with reference to FIGS. 36 and 37, in a case where the disconnection UI is displayed on the user operation terminal 20, one of the warning screens including an operation prohibition message described with reference to FIGS. 36 and 37 is displayed together with the UI.

Furthermore, in step S422, the control unit of the user non-operation terminal 30 also performs the function restriction of the user non-operation terminal 30. For example, function restriction processing such as decreasing the processing speed of the CPU is executed. The restriction level of the function restriction executed here, however, is high, which is higher than the function restriction level achieved in step S407.

The control unit of the user operation terminal 20 or the user non-operation terminal 30 thus displays one of various warning screens on the display unit in accordance with the temperature of the user non-operation terminal 30.

That is, one of the various warning screens described with reference to FIGS. 30 to 38 is displayed on the display unit of the user operation terminal 20 or the user non-operation terminal 30.

By viewing this warning screen, the user can accurately learn the temperature state of the user non-operation terminal 30, and it is possible to prevent occurrence of a low-temperature burn or the like due to an erroneous operation.

### 10. Other Embodiments and Application Examples

Next, other embodiments and application examples will be described.

As described above, the processing in the present disclosure has a configuration in which the user operation terminal 20 on which the user displays a game screen or the like when executing a game app or the like and that is directly operated by the user and the user non-operation terminal 30 that generates an app screen, that is, generates a 3D image, for example, without displaying a game app screen are connected to each other.

With such a configuration, load distribution is performed in the two terminals, and a temperature rise of the user operation terminal 20 operated by the user can be suppressed, so that the user can execute an app of a game or the like for a long time.

A temperature reduction effect produced by the load distribution is particularly large in, for example, a game app with a high frame rate or a game app that requires generation of 3D images.

Since the load on the user operation terminal 20 operated by the user is reduced by using the configuration in the present disclosure, it is assumed that a margin is generated in the processing of the control unit of the user operation terminal 20. Using this margin, it is also possible to cause the user operation terminal 20 to execute, for example, new processing.

For example, it is also possible to execute processing for recording an execution screen of a game app or external distribution processing via a network in the user operation terminal 20. Since the processing for generating an image with a high processing load is executed on the user non-operation terminal 30 side, it is unlikely that a large temperature rise occurs even if such processing is performed in the user operation terminal 20.

Note that, in order to reduce the temperature rise of the user non-operation terminal 30, for example, a cooler such as a fan may be attached.

There are many users who do not desire to wear a cooler such as a fan on a terminal that the user directly operates because the cooler is noisy or interferes with user operations, but since the user non-operation terminal 30 can be placed at a position away from the user in the processing in the present disclosure, sound is not noticeable. In addition, there is an advantage that game play of the user is not interfered with.

### 11. Configuration Example of Information Processing Apparatus in Present Disclosure

Next, a configuration example of the information processing apparatus in the present disclosure will be described.

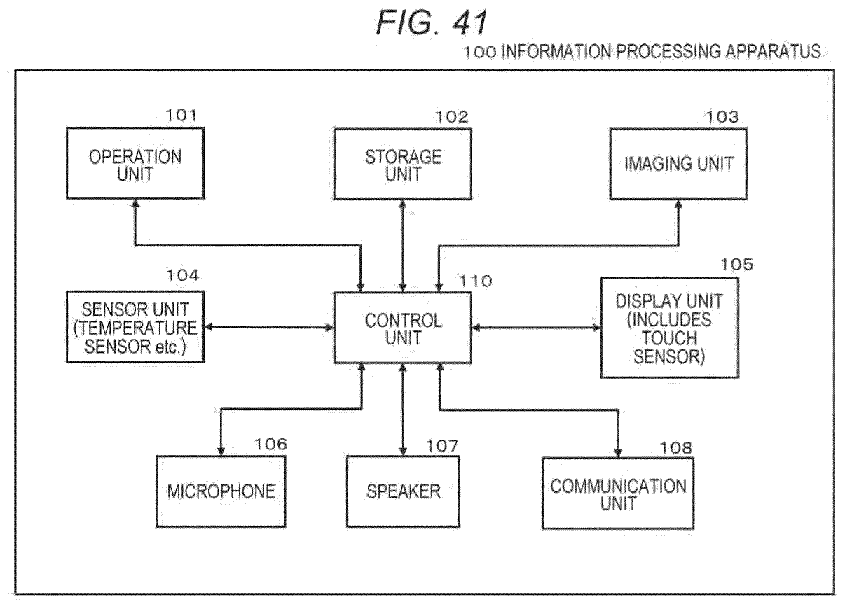

FIG. 41 is a block diagram illustrating a functional configuration of the information processing apparatus in the present disclosure, that is, an information processing apparatus such as a smartphone.

As illustrated in FIG. 41, an information processing apparatus 100 includes an operation unit 101, a storage unit 102, an imaging unit 103, a sensor unit (temperature sensor or the like) 104, a display unit 105, a microphone 106, a speaker 107, a communication unit 108, and a control unit 110.

The operation unit 101 detects various operations performed by the user, such as device operations for an application.

Note that the device operations include, for example, an operation on a power button, touch processing (taps, flicks, swipes, and the like) on the display unit, and the like.

Touch operation information for the operation unit 101 including, for example, the power button and the display unit is input to the control unit 110.

The storage unit 102 is a storage area for temporarily or permanently storing various programs and data.

For example, the storage unit 102 stores programs and data for the information processing apparatus 100 to execute various functions. As a specific example, the storage unit 102 stores a program for executing various applications, management data for managing various settings, and the like.

In addition, the storage unit 102 also stores icons, warning messages, and the like corresponding to various terminal temperatures described above. These are stored in association with the temperature information.

The imaging unit 103 images, for example, the face and the like of a user who operates the information processing apparatus 100 under the control of the control unit 110.

The sensor unit 104 includes, for example, an acceleration sensor, a gyro sensor, a vibration sensor, a proximity sensor, an illuminance sensor, a GPS signal reception sensor, and the like in addition to a temperature sensor.

Detection information of the sensor unit 104 is input to the control unit 110.

The display unit 105 displays various types of information under the control of the control unit 110. The display unit 105 displays, for example, an application execution screen.

The display unit 105 can include one of various display devices including a liquid crystal display (LCD) device and an organic light emitting diode (OLED) display device.

In addition, the display unit 105 controls processing for displaying and stopping (turning off) the application execution screen under the control of the control unit 110.

The microphone 106 includes a microphone or the like that collects voice and the like uttered by the user under the control of the control unit 110.

The speaker 107 outputs various sounds. For example, the speaker 107 outputs voices and sounds according to a status of the application under the control of the control unit 110.

The communication unit 108 includes a plurality of communication paths including the Internet used for communication with an external apparatus such as a game server in addition to a communication path for executing communication with a connected terminal. Note that, as described above, the communication path for executing communication with the connected terminal can be configured by, for example, either a wired communication path such as USB or LAN or a wireless communication path such as WLAN (wireless LAN).

That is, the communication unit 108 functions as a transmission/reception unit for wired communication such as USB or LAN, for example, and Wi-Fi communication, Bluetooth (registered trademark) (BT) communication, and other types of data communication via a network such as the Internet or a local area network, and communicates with external devices such as a connected terminal and a server.

The control unit 110 controls, for example, display data to be output to the display unit 105 and transmission data to be transmitted via the communication unit 108.

In addition, the control unit 110 performs app control such as activation, execution, and stop of an application on the basis of user operations on the operation unit 101.

In addition, for example, the control unit 110 performs processing for displaying the various icons and messages described above on the display unit 105.

The control unit 110 further executes data communication control via the communication unit 108.

In addition, in a case where the information processing apparatus 100 is the user non-operation terminal 30, the control unit 110 performs application execution control on the basis of user operation information or the like input from the connected terminal (user operation terminal 20) via the communication unit 108, and also performs processing such as generation and update of image data, sound data, and vibration data to be generated.

Although a functional configuration example of the information processing apparatus 100 has been described here, the functional configuration described above with reference to FIG. 41 is merely an example, and the functional configuration of the information processing apparatus 100 according to the present embodiment is not limited to this example.

For example, the information processing apparatus 100 need not necessarily include all of the components illustrated in FIG. 41, and may include some components in another apparatus different from the information processing apparatus 100.

The functional configuration of the information processing apparatus 100 according to the present embodiment can be flexibly modified in accordance with specifications and operations.

In addition, the function of each component may be performed by reading a control program from a storage medium such as a read only memory (ROM) or a random access memory (RAM) storing a control program describing a processing procedure in which an arithmetic device such as a central processing unit (CPU) implements these functions, and interpreting and executing the program.

The configuration to be used, therefore, may be appropriately changed in accordance with a technical level at the time of implementing the present embodiment.

### 12. Hardware Configuration Example of Information Processing Apparatus in Present Disclosure

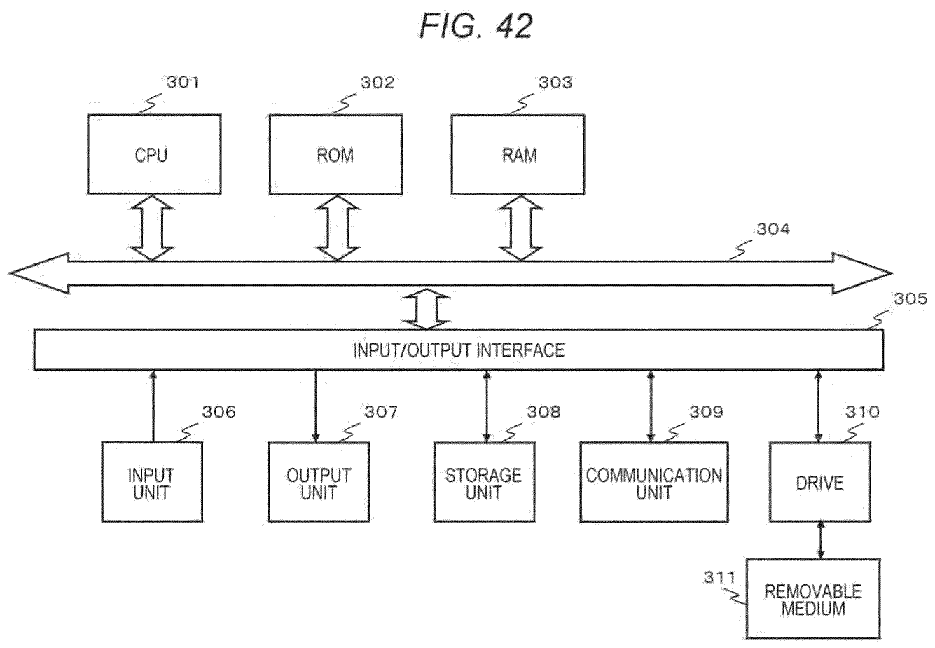

Next, a hardware configuration example of the information processing apparatus in the present disclosure will be described with reference to FIG. 42.

Note that hardware of the information processing apparatus illustrated in FIG. 42 corresponds to hardware of a smartphone, which is an example of the information processing apparatus in the present disclosure.

Each of components constituting the hardware of the information processing apparatus illustrated in FIG. 42 will be described hereinafter.

A central processing unit (CPU) 301 functions as a control unit and a data processing unit that performs various kinds of processing in accordance with a program stored in a read only memory (ROM) 302 or a storage unit 308. For example, the CPU 301 executes the processing according to the sequence described in the above-described embodiments. A random access memory (RAM) 303 stores programs, data, or the like to be performed by the CPU 301. The CPU 301, the ROM 302, and the RAM 303 are connected to one another by a bus 304.

The CPU 301 is connected to an input/output interface 305 via the bus 304, and the input/output interface 305 is connected to an input unit 306 including various switches, buttons, a touch panel, a microphone, or the like and an output unit 307 that outputs data to a display unit, a speaker, or the like. The CPU 301 performs various processes in accordance with a command input from the input unit 306, and outputs a processing result to the output unit 307, for example.

The storage unit 308 connected to the input/output interface 305 stores a program to be executed by the CPU 301 and various types of data. The communication unit 309 functions as a transmission-reception unit for Wi-Fi communication, Bluetooth (registered trademark) (BT) communication, and other types of data communication via a network such as the Internet or a local area network, and communicates with external devices.

A drive 310 connected to the input/output interface 305 drives a removable medium 311 that is a semiconductor memory or the like such as a memory card, and stores or reads data.

### 13. Summary of Configuration in Present Disclosure

Embodiments of the present disclosure have been described above in detail with reference to specific embodiments. It is obvious, however, that those skilled in the art can modify or substitute the embodiments without departing from the gist of the present disclosure. That is, the present invention has been disclosed in the form of exemplification, and should not be interpreted in a limited manner. In order to determine the gist of the present disclosure, the claims should be considered.

Note that the technology disclosed herein can have the following configurations.
(1) An information processing apparatus including:
a control unit that executes an application; and
a communication unit that executes communication with a connected terminal operated by a user, in which
the control unit
executes processing for transmitting image data generated by executing the application to the connected terminal via the communication unit, and further
updates the generated image data in accordance with user operation information regarding the connected terminal input from the connected terminal via the communication unit and transmits the image data to the connected terminal.
(2) The information processing apparatus according to (1), in which the control unit
executes processing for transmitting sound data generated by executing the application to the connected terminal via the communication unit, and further
updates the generated sound data in accordance with the user operation information regarding the connected terminal input from the connected terminal via the communication unit and transmits the sound data to the connected terminal.
(3) The information processing apparatus according to (1) or (2), in which the control unit
executes processing for transmitting vibration data generated by executing the application to the connected terminal via the communication unit, and further
updates the generated vibration data in accordance with the user operation information regarding the connected terminal input from the connected terminal via the communication unit and transmits the vibration data to the connected terminal.
(4) The information processing apparatus according to any one of (1) to (3), in which the control unit
inputs touch position information with respect to a display unit of the connected terminal as the user operation information regarding the connected terminal, and executes processing for updating output data for the connected terminal in accordance with an input touch position.
(5) The information processing apparatus according to any one of (1) to (4), in which the control unit
inputs touch mode information with respect to a display unit of the connected terminal as the user operation information regarding the connected terminal, and executes processing for updating output data for the connected terminal in accordance with an input touch mode.
(6) The information processing apparatus according to any one of (1) to (5), in which the control unit
executes processing for displaying a user interface (UI) for setting a communication mode with the connected terminal on a display unit, and
the UI is a UI that enables setting of at least one of a frame rate or resolution of an image to be output to the connected terminal.
(7) The information processing apparatus according to (6), in which the UI is a UI that enables setting of whether or not to output at least one of sound data and vibration data to the connected terminal.
(8) The information processing apparatus according to (6) or (7), in which the UI is a UI that enables selection of information to be input from the connected terminal.
(9) The information processing apparatus according to any one of (1) to (8), in which the control unit
inputs a detected value of a temperature sensor attached to the information processing apparatus, and
displays, on a display unit, a warning screen corresponding to a temperature of the information processing apparatus determined on a basis of the input detected value of the temperature sensor.
(10) The information processing apparatus according to (9), in which the control unit
selects a warning screen to be output in accordance with which of a plurality of predetermined temperature ranges the temperature of the information processing apparatus falls within, and displays the warning screen on the display unit.
(11) The information processing apparatus according to (10), in which the control unit
determines which one of following predetermined references 1 to 3 the temperature of the information processing apparatus falls under, namely
(reference 1) a temperature range in which normal operations can be performed;
(reference 2) a temperature range in which there is no risk of a low-temperature burn if an operation is performed within a predetermined time; and
(reference 3) a temperature range higher than reference 2 in which a high-temperature burn does not occur immediately by touching, and
selects a warning screen to be output in accordance with a result of the determination and displays the selected warning screen on the display unit.
(12) The information processing apparatus according to (11), in which the control unit
displays, on the display unit, a warning screen including operable time information for which it is determined that there is no possibility of occurrence of a low-temperature burn
in a case where the temperature of the information processing apparatus falls under reference 2.
(13) The information processing apparatus according to (11) or (12), in which the control unit
displays, on the display unit, a warning screen notifying of operation prohibition
in a case where the temperature of the information processing apparatus falls under reference 3.
(14) The information processing apparatus according to any one of (1) to (13), in which the control unit
inputs a detected value of a temperature sensor attached to the information processing apparatus, and
transmits the input detected value of the temperature sensor or a temperature identification icon generated on a basis of the detected value of the temperature sensor to the connected terminal and displays the detected value or the temperature identification icon on a display unit of the connected terminal.
(15) The information processing apparatus according to (14), in which the control unit further
determines, on a basis of the detected value of the temperature sensor, whether or not the information processing apparatus is operable, transmits an operability message based on a result of the determination to the connected terminal, and displays the operability message on the display unit of the connected terminal.
(16) An information processing apparatus including:
a communication unit that executes communication with a connected terminal which executes an application; and
a control unit that executes communication control using the communication unit, in which
the control unit
displays, on a display unit, image data as an application execution result input from the connected terminal via the communication unit, and
transmits user operation information regarding the information processing apparatus to the connected terminal via the communication unit.
(17) The information processing apparatus according to (16), in which the control unit
displays, on the display unit, at least one of a temperature identification icon indicating a temperature of the connected terminal input from the connected terminal via the communication unit and an operability message indicating whether or not the connected terminal is operable.
(18) The information processing device according to (16) or (17), in which, in a case where disconnection processing in relation to the connected terminal is detected, or in a case where a start of disconnection processing in relation to the connected terminal is detected,
the control unit
displays, on the display unit, at least one of operability information regarding the connected terminal, operable time information regarding the connected terminal, and notification information for notifying that the connected terminal can be operated from the information processing apparatus by maintaining connection with the connected terminal.
(19) An information processing system including:
a user non-operation terminal and a user operation terminal, in which
the user non-operation terminal executes
processing for transmitting image data generated by executing an application to the user operation terminal via a communication unit, and
processing for updating the image data on a basis of user operation information input from the user operation terminal via the communication unit, and
the user operation terminal executes
processing for displaying, on a display unit, the image data as an application execution result input from the user non-operation terminal via the communication unit, and
processing for transmitting the user operation information regarding the information processing apparatus to the user non-operation terminal via a communication unit.
(20) An information processing method executed by an information processing apparatus,
the information processing apparatus including:
a control unit that executes an application; and
a communication unit that executes communication with a connected terminal operated by a user,
the information processing method including:
executing, using the control unit, processing for transmitting image data generated by executing the application to the connected terminal via the communication unit; and further
updating, using the control unit, the generated image data in accordance with user operation information regarding the connected terminal input from the connected terminal via the communication unit and transmitting the image data to the connected terminal.

In addition, a series of processes described herein can be executed by hardware, software, or a combined configuration of hardware and software. In a case where processing based on software is executed, a program in which a processing sequence is recorded can be installed in a memory in a computer incorporated in dedicated hardware and executed, or the program can be installed in a general-purpose computer capable of executing various types of processing and executed. For example, the program may be stored in advance in a storage medium. Instead of installing the program on a computer from a storage medium, the program may be received via a network such as a local area network (LAN) or the Internet, and installed in a storage medium such as an internal hard disk or the like.

Note that the various types of processing described herein may be executed not in a chronological order in accordance with the description, but in parallel or individually depending on processing capability of an apparatus that executes the processing or depending on the necessity. In addition, a system in the present specification is a logical assembly of a plurality of apparatuses, and is not limited to one in which apparatuses of different configurations are in the same housing.

### INDUSTRIAL APPLICABILITY

As described above, with a configuration according to an embodiment of the present disclosure, a configuration capable of suppressing a temperature rise of a user terminal such as a smartphone and checking a temperature status of the user terminal is achieved.

Specifically, for example, in a configuration in which a user non-operation terminal and a user operation terminal are communicably connected to each other, image data generated by the user non-operation terminal executing an app is transmitted to the user operation terminal, and the image data is updated on the basis of user operation information input from the user operation terminal. The user operation terminal displays image data as an application execution result input from the user non-operation terminal on the display unit, and transmits user operation information regarding the user operation terminal to the user non-operation terminal. Furthermore, warning information or the like according to the temperature of the user non-operation terminal is displayed on the user non-operation terminal or the user operation terminal.

With these configurations, a configuration capable of suppressing a temperature rise of a user terminal such as a smartphone and checking a temperature status of the user terminal is achieved.

### REFERENCE SIGNS LIST

10 User (player)
15 User terminal
20 User operation terminal
21 Connected terminal temperature identification icon
22 Connected terminal operability message
30 User non-operation terminal
50 Game server
51 User terminal
100 Information processing apparatus
101 Operation unit
102 Storage unit
103 Imaging unit
104 Sensor unit
105 Display unit
106 Microphone
107 Speaker
108 Communication unit
110 Control unit
301 CPU
302 ROM
303 RAM
304 Bus
305 Input/output interface
306 Input unit
307 Output unit
308 Storage unit
309 Communication unit
310 Drive
311 Removable medium

1. An information processing apparatus comprising:
a control unit that executes an application; and
a communication unit that executes communication with a connected terminal operated by a user, wherein
the control unit
executes processing for transmitting image data generated by executing the application to the connected terminal via the communication unit, and further
updates the generated image data in accordance with user operation information regarding the connected terminal input from the connected terminal via the communication unit and transmits the image data to the connected terminal.

2. The information processing apparatus according to claim 1, wherein the control unit
executes processing for transmitting sound data generated by executing the application to the connected terminal via the communication unit, and further
updates the generated sound data in accordance with the user operation information regarding the connected terminal input from the connected terminal via the communication unit and transmits the sound data to the connected terminal.

3. The information processing apparatus according to claim 1, wherein the control unit
executes processing for transmitting vibration data generated by executing the application to the connected terminal via the communication unit, and further
updates the generated vibration data in accordance with the user operation information regarding the connected terminal input from the connected terminal via the communication unit and transmits the vibration data to the connected terminal.

4. The information processing apparatus according to claim 1, wherein the control unit
inputs touch position information with respect to a display unit of the connected terminal as the user operation information regarding the connected terminal, and executes processing for updating output data for the connected terminal in accordance with an input touch position.

5. The information processing apparatus according to claim 1, wherein the control unit
inputs touch mode information with respect to a display unit of the connected terminal as the user operation information regarding the connected terminal, and executes processing for updating output data for the connected terminal in accordance with an input touch mode.

6. The information processing apparatus according to claim 1, wherein the control unit
executes processing for displaying a user interface (UI) for setting a communication mode with the connected terminal on a display unit, and
the UI is a UI that enables setting of at least one of a frame rate or resolution of an image to be output to the connected terminal.

7. The information processing apparatus according to claim 6, wherein the UI is a UI that enables setting of whether or not to output at least one of sound data and vibration data to the connected terminal.

8. The information processing apparatus according to claim 6, wherein the UI is a UI that enables selection of information to be input from the connected terminal.

9. The information processing apparatus according to claim 1, wherein the control unit
inputs a detected value of a temperature sensor attached to the information processing apparatus, and
displays, on a display unit, a warning screen corresponding to a temperature of the information processing apparatus determined on a basis of the input detected value of the temperature sensor.

10. The information processing apparatus according to claim 9, wherein the control unit
selects a warning screen to be output in accordance with which of a plurality of predetermined temperature ranges the temperature of the information processing apparatus falls within, and displays the warning screen on the display unit.

11. The information processing apparatus according to claim 10, wherein the control unit
determines which one of following predetermined references 1 to 3 the temperature of the information processing apparatus falls under, namely
(reference 1) a temperature range in which normal operations can be performed;
(reference 2) a temperature range in which there is no risk of a low-temperature burn if an operation is performed within a predetermined time; and
(reference 3) a temperature range higher than reference 2 in which a high-temperature burn does not occur immediately by touching, and
selects a warning screen to be output in accordance with a result of the determination and displays the selected warning screen on the display unit.

12. The information processing apparatus according to claim 11, wherein the control unit
displays, on the display unit, a warning screen including operable time information for which it is determined that there is no possibility of occurrence of a low-temperature burn
in a case where the temperature of the information processing apparatus falls under reference 2.

13. The information processing apparatus according to claim 11, wherein the control unit
displays, on the display unit, a warning screen notifying of operation prohibition
in a case where the temperature of the information processing apparatus falls under reference 3.

14. The information processing apparatus according to claim 1, wherein the control unit
inputs a detected value of a temperature sensor attached to the information processing apparatus, and
transmits the input detected value of the temperature sensor or a temperature identification icon generated on a basis of the detected value of the temperature sensor to the connected terminal and displays the detected value or the temperature identification icon on a display unit of the connected terminal.

15. The information processing apparatus according to claim 14, wherein the control unit further
determines, on a basis of the detected value of the temperature sensor, whether or not the information processing apparatus is operable, transmits an operability message based on a result of the determination to the connected terminal, and displays the operability message on the display unit of the connected terminal.

16. An information processing apparatus comprising:
a communication unit that executes communication with a connected terminal which executes an application; and
a control unit that executes communication control using the communication unit, wherein
the control unit
displays, on a display unit, image data as an application execution result input from the connected terminal via the communication unit, and
transmits user operation information regarding the information processing apparatus to the connected terminal via the communication unit.

17. The information processing apparatus according to claim 16, wherein the control unit
displays, on the display unit, at least one of a temperature identification icon indicating a temperature of the connected terminal input from the connected terminal via the communication unit and an operability message indicating whether or not the connected terminal is operable.

18. The information processing device according to claim 16, wherein, in a case where disconnection processing in relation to the connected terminal is detected, or in a case where a start of disconnection processing in relation to the connected terminal is detected,
the control unit
displays, on the display unit, at least one of operability information regarding the connected terminal, operable time information regarding the connected terminal, and notification information for notifying that the connected terminal can be operated from the information processing apparatus by maintaining connection with the connected terminal.

19. An information processing system comprising:
a user non-operation terminal and a user operation terminal, wherein
the user non-operation terminal executes
processing for transmitting image data generated by executing an application to the user operation terminal via a communication unit, and
processing for updating the image data on a basis of user operation information input from the user operation terminal via the communication unit, and
the user operation terminal executes
processing for displaying, on a display unit, the image data as an application execution result input from the user non-operation terminal via the communication unit, and
processing for transmitting the user operation information regarding the information processing apparatus to the user non-operation terminal via a communication unit.

20. An information processing method executed by an information processing apparatus,
the information processing apparatus including:
a control unit that executes an application; and
a communication unit that executes communication with a connected terminal operated by a user,
the information processing method comprising:
executing, using the control unit, processing for transmitting image data generated by executing the application to the connected terminal via the communication unit; and further
updating, using the control unit, the generated image data in accordance with user operation information regarding the connected terminal input from the connected terminal via the communication unit and transmitting the image data to the connected terminal.
